(19) United States
(12) Patent Application Publication
(10) Pub. No.: US 2003/0028676 A1
(43) Pub. Date: Feb. 6, 2003

(54) Field technician virtual trainer

(76) Inventors: David M. Pangrac, Port Aransas, TX (US); Donald T. Gall, Port Aransas, TX (US)

Correspondence Address: Gary R. Stanford, Law Offices of Gary R. Stanford, 610 West Lynn, Austin, TX, 78703, US

(21) Appl. No.: 10/185,762

(22) Filed: Jun. 27, 2002

Related U.S. Application Data
(60) Provisional application No. 60/301,733, filed on Jun. 28, 2001.

(51) Int. Cl. G06F 15/16

(52) U.S. Cl. 709/250

(57) ABSTRACT

A technician trainer including interactive software executed on a computer that gives broadband telecommunication field technicians a comprehensive way to practice and improve troubleshooting skills to accelerate the training process. The trainer provides an interactive virtual broadband communication network environment that incorporates a virtual working cable plant which simulates real-world situations. The tech trainer incorporates proper diagnostic and trouble-shooting procedures that enables the user/technician to recognize and practice proper procedures through virtual experience and repetition to improve field performance. The trainer presents the user with a work order indicative of a network problem and various selectable options and actions. The interactive environment includes network components that are programmed with measurable values that reflect the network problem, and further includes interactive selectable tools and test equipment for taking measurements.

### FIELD OF THE INVENTION

The present invention relates to broadband telecommunications and training, and more particularly, to a technician trainer application that provides interactive computer simulated training for field technicians.

### BACKGROUND OF THE INVENTION

Training is one of the biggest issues in setting up and maintaining broadband telecommunication networks. As a rule, field technicians must almost always have to be trained to solve the problems that arise in the field. Most of the time, however, they do not know how to set up test equipment or they do not know how systems are supposed to work. Field technicians have many job responsibilities, including setting up networks and diagnosing and repairing network problems associated therewith. Such responsibilities are difficult for untrained personnel.

It is desirable that each technician understand the theory behind the network that they are servicing. Radio Frequency (RF) theory, however, is not always straight-forward or simple, and often requires a certain amount of study for even cursory levels of comprehension. Such theory, however, has been taught and continues to be taught the traditional old way, including a certain amount of book learning combined with the classroom training methods. In general, field technicians are people who like to work with their hands and who generally seek activity-related jobs. The typical field technician is not inclined to learn via standard teaching and training methods and usually avoids formal education, especially long-term (e.g., 2-4 years) educational programs. Such people often avoid even short-term RF theory training courses that would otherwise assist them with the theory of operation of the networks they are servicing.

It is possible to be a good technician without having a complete understanding of the RF theory behind the broadband telecommunication network operation. The technician can be trained to inspect network components and cables and make rudimentary measurements to locate, identify and repair a network problem without fully understanding network operation. The technician eventually learns to observe characteristics of a received signal, such as on a television screen at a subscriber's home, identify one or more potential solutions, and to track down or take measurements to identify the source of the problem.

Technicians tend to be trained on the job with an experienced mentor and ultimately through their own experience. Many have the capacity to understand the general concepts and theory, but would rather learn it on-thejob and avoid traditional or formal training processes. However, such on-the-job training takes a substantial amount of time and may be very costly. The un-trained technician often makes costly mistakes in terms of time and cost to both the technician and his/her employer. Failure to follow proper procedure may result in any one or more of several undesirable results, such as inadequate or inefficient problem resolution, substantial loss of time and/or resources, damage to test equipment, injury to or death of the technician, angry subscribers, loss of subscribers, etc.

### BRIEF DESCRIPTION OF THE DRAWINGS

For a more complete understanding of the present invention, reference is now made to the following description taken in conjunction with the accompanying drawings in which like reference numerals indicate like features and wherein:

FIG. 1 is a flow diagram illustrating an overview of a navigation scheme of a tech trainer implemented according to one embodiment of the present invention.

FIGS. 2-25 are figurative block diagrams of clickable graphic screens illustrating a house drop simulator subscriber location graphic interface.

FIG. 26 is an exemplary flow diagram illustrating basic logical flow for a two-port tap.

FIG. 27 is a screen shot of an exemplary virtual meter that is employed for making measurements at appropriate locations in the network.

FIGS. 28-43 are flow diagrams illustrating exemplary proper test procedures that form the basis associated with actual scenarios programmed into the tech trainer simulator.

FIGS. 44-85 are exemplary screen shots illustrating an exemplary trouble ticket and selectable options in a virtual tech trainer session.

FIG. 86 is a block diagram of an exemplary training workstation including a computer with input/output (I/O) devices to provide an interactive training environment.

### DETAILED DESCRIPTION OF EMBODIMENTS OF THE INVENTION

A technician trainer (“tech trainer”) according to an embodiment of the present invention is an interactive software package that gives broadband telecommunication field technicians a comprehensive way to practice and improve troubleshooting skills. The software is executed on a computer system or the like with various input/output (I/O) devices including a display to provide an interactive virtual broadband communication network environment. The tech trainer is an interactive training tool that incorporates a virtual or replicate of a working cable plant and simulates real-world situations, much like a flight simulator. In one embodiment, a software game engine may be employed to enhance the interactive experience. The tech trainer may not necessarily replace many aspects of actual on-the-job training, but significantly accelerates the training process and enhances real-world experience. The tech trainer anticipates costly mistakes and allows the user/technician to recognize and avoid such mistakes through virtual experience and repetition, so that such mistakes are avoided in actual practice. In a similar manner, the tech trainer incorporates proper diagnostic and trouble-shooting procedures and allows the user/technician to recognize and practice proper procedures through virtual experience and repetition, so that such proper procedures will be practiced in the field.

The tech trainer “user” is presented with a randomly selected or software-generated network problem indicated by a trouble ticket or work order or the like including one or more subscriber complaints and/or observations. A “user” is a technician or technician in training using the tech trainer. The user is further presented with various selectable options and actions that each present further results and/or further selectable options and actions, so that the user traverses any one of many possible paths in an attempt to solve the problem presented. The user works his or her way through the problem in a virtual network that provides a realistic environment. In one embodiment, the tech trainer is configured as an interactive computer game that simulates real-world situations and environments in order to enhance the training process. The tech trainer may further allow repetitive practice and provide or enable mentoring guidance as the user progresses through the interactive training process.

Every conceivable problem and situation that can occur in the field can be developed and presented as a simulation. Each user's progress may be monitored and logged so that he/she learns to solve certain problems and is continuously exposed to new options. The end result is that the user ultimately achieves success in diagnosing and solving a plethora of network problems in an efficient and cost-effective manner. The user/technician learns diagnostic and practical skills through virtual troubleshooting scenarios allowing repetitive training and practice that leads to the development of “good” habits and that discourages “bad” habits.

The use of the tech trainer eliminates a substantial amount of on-the-job training and potentially avoids embarrassing or costly mistakes and/or accidents. For example, steps that might otherwise lead to damage to network components or equipment are inconsequential in the simulated environment, much like a crash is inconsequential in a flight simulator. Also, failure of the user to “wear” the appropriate attire, take the appropriate precautions, or properly conduct themselves with subscribers may result in virtual mistakes or costs that are logged for purposes of training, but that do not have any real-world consequences. Examples include failure of the user to take the step of wearing proper safety equipment before climbing a telephone pole (which may lead to temporary or permanent injury), failure to heed notes or warnings in the trouble ticket (which may lead to begin chased by a virtual dog), an attempt to adjust the subscriber's television set (which may lead to an angry subscriber or a damaged television), etc. The tech trainer further significantly reduces the time and cost of training in a manner that is both efficient and enjoyable. For example, the tech trainer enhances the training process by eliminating real-world time and costs that would otherwise be encountered during on-the-job type training, such as travel time and costs to and from work sites or subscriber premises, time for setting up equipment for conducting measurements or tests, costs of consumables that may or may not be billable to the subscriber, etc.

An administrator may directly observe and evaluate user's troubleshooting skills via his/her actions or decisions, and can enhance the training process by offering praise or rewards or by offering suggestions for alternative actions and decisions. The user's actions and decisions in the simulation process may be logged and evaluated in terms of cost and efficiency in the form of one or more “score” parameters. The tech trainer may include a reporting function to enable an administrator to assess the user's performance and skill-level, as well as the costs and length of time associated with the user's responses and choices during one or more training sessions.

The tech trainer application may be implemented in any one of several manners. In one embodiment, the tech trainer includes a menu-driven portion in which the user is presented with a series of pages or screen shots, each with one or more selectable options. Such menu-driven presentation may be primarily textual in nature in which each screen explains the situation or results of the user's selections and one or more options that the user has at that point. The tech trainer application may be enhanced with pictures that may or may not include interactive portions. For example, the user may be presented with an interactive picture of a generic test device that enables him/her to virtually press buttons and turn dials to setup the equipment to take a measurement. The interactive pictures may include scene shots, such as a subscriber's location, a telephone pole, etc. The pictures may include actual pictures of devices or components. The tech trainer application may be enhanced with audio/video clips to enrich the virtual experience. For example, a picture or video conveying the appearance of a signal displayed on the subscriber's television set or a test television set may be displayed for purposes of diagnosis. Audio clips are included to guide a user and aid in the diagnostic procedure.

An interactive game-styled scenario is contemplated (employing a software game-engine or the like) in which the user may have the options of opening a gate of a fence to access the subscriber's property, knocking on doors, interacting with a subscriber character, accessing and viewing the subscriber's television, etc. Some actions may have consequences, such as being chased or attacked by a dog, falling off a telephone pole, interfacing an angry subscriber, etc. Regardless of the specific presentation format, a virtual representation of a cable plant including one or more subscriber neighborhoods with selectable network components is provided for perusal and inspection. An interactive network map of the cable plant is provided for selection along with selectable network component graphics. Selection of a network component graphic in the network map provides further information about the selected component. The software incorporates virtual measurable values associated with network components of the cable plant of the communication network environment. The measurable values are indicative of network status and operation and reflect a selected network problem. The software presents selectable virtual tools and test equipment that enables the user to determine the measurable values of the network components to simulate trouble-shooting procedure. The software incorporates tracking and logging functions and proper procedural information that collectively facilitate evaluation of user performance and progress.

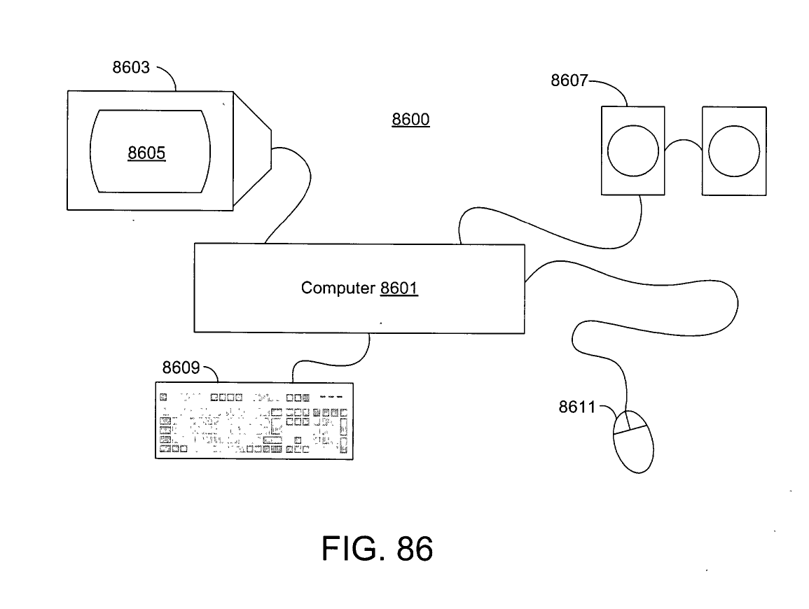

FIG. 86 is a block diagram of an exemplary training workstation 8600 including a computer 8601 with input/output (I/O) devices to provide an interactive training environment. The computer 8601 includes appropriate components for receiving and executing software programs and the like, such as a processor, a memory and storage devices as known to those skilled in the art. The I/O devices include, for example, a monitor 8603 with a display 8605 for visual output and speakers 8607 for audio output. Several input devices are contemplated, such as a keyboard 8609 and mouse 8611. The workstation 8600 provides a suitable format for establishing an interactive virtual broadband communication network environment in accordance with embodiments of the present invention. Although illustrated in desktop format, alternatives and variations are contemplated, such as laptop computers, portable computers, and various hand-held devices.

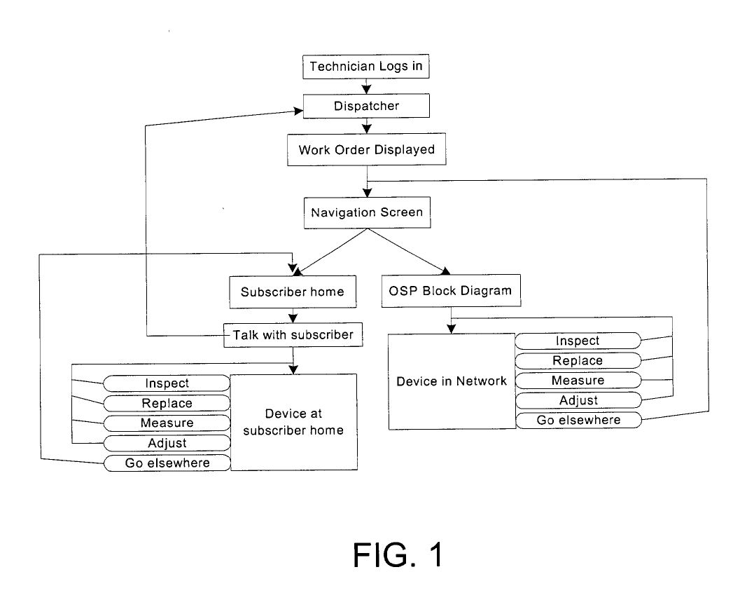

FIG. 1 is a flow diagram illustrating an overview of a navigation scheme of a tech trainer implemented according to one embodiment of the present invention. The tech trainer is graphics driven and navigated according to selections by the user. The user initiates the program and logs in, and is provided with a work order from a dispatcher, which is displayed to the user. The user then proceeds to a navigation screen, in which the user is provided the choice of traveling to the subscriber location or to the relevant network neighborhood or geographic network location. At the subscriber location, the user may “talk” with the subscriber, if home, and may then proceed to perform one or more actions associated with any one or more devices at the subscriber's home, including inspect, replace, measure, adjust, etc. The simulation may include a virtual conversation with the subscriber, or may provide a subscriber discussion selection and corresponding discussion summary. If the subscriber is virtually not home, the technician may report back to the dispatcher, or, depending upon the trouble ticket, may proceed to examine the network in the neighborhood. The user may select to view a map or OSP (OutSide Plant) block diagram of the network in the subscriber's area. In this case, the user may proceed to perform one or more actions associated with any one or more devices or components in the network, including inspect, replace, measure, adjust, etc. It is appreciated that the flowchart of FIG. 1 is only a simplified representation of the overall program, and that many specific steps and scenarios have been omitted for purposes of clarity.

There are many components or modules of the simulator that may be loaded-in prior to each simulation session, either automatically or by selection of an administrator or the like. A dispatch module generates each work order and is where the technician goes to complete the work order, goes to get another work order, or goes for help. The components may form a virtual network system, including data and information associated with a cable network headend or central location, including analog television (TV) channels, digital TV channels, digital communication signals in the “forward” or downstream direction and in the “reverse” or upstream direction. The network may further include data and information associated with an outside plant incorporating a complete system block diagram with intersection points and devices, where each point has a gain or loss block or the like. The network may further include data and information associated with a subscriber premises, which is similar to the outside plant module, except that it considers the tap levels as its signal source. Each subscriber location has its own block diagram with gain or loss blocks. An exemplary trip time from the office to the relevant outside plant or a subscriber premises may be determined for purposes of tracking and logging, but the actual time need not be wasted during the simulation.

Many program modules may run alongside the main program. For example, an RF Module is called up and executed that calculates the signal level at any point in the network. The RF module bases measurement on signal sources including starting levels in a selected scale, such as dBmV, gain blocks, loss blocks, defect blocks including anomalies inserted into the network, etc. The RF module allows virtual test equipment modules to calculate and display signal levels at any point in the network. The user selects a device and a virtual test equipment selection to perform a measurement.

The tech trainer may include an operations module that tracks the ‘score’ of the user as the problem is worked through the simulation based on the user's actions and selections. For example, the operations module may track truck stock that could be established automatically or requisitioned by the technician. The truck stock is drawn down and costs are tracked as consumables are used. The operations module assesses whether or not the stock selected and used by the user are billable to the customer. Windshield time is also tracked if a needed part is not on the truck. The overall time used is tracked, where each task has a value including windshield time and unnecessary steps that could have associated penalties. In this manner, the simulation scores a cost per truck-roll which is maintained in the user's file.

An administrator functions module enables an administrator to load the various characteristics into the environment, including, for example, signal sources (by channel), normal gains and losses, network defects, subscriber premises defects, random elements (e.g., bad weather, difficult customers, etc.), truck stock, etc.

A reporting functions module enables an administrator to obtain information about the outcome of each session and the accumulated scores for multiple sessions. The reporting functions module may assess difficulty level, performance against objective standards, cost of the truck-roll net of subscriber billings, length of time to correct problem, accuracy of paperwork filled out by the user, etc.

Additional levels of complexity may be introduced. A tools module may be executed alongside the other modules, in which it is necessary for the user to select the tool before ‘doing’ anything. This could help to reinforce system policies such as: did the technician employ proper procedures before going up to the tap?, etc.; did the technician install a bypass device before removing a network device?; does the technician need to go back to the truck to get a meter before reading it?; etc.

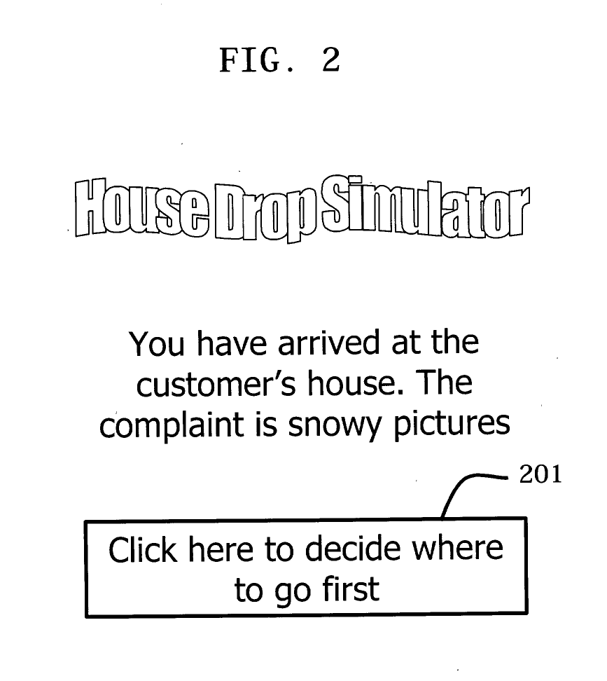

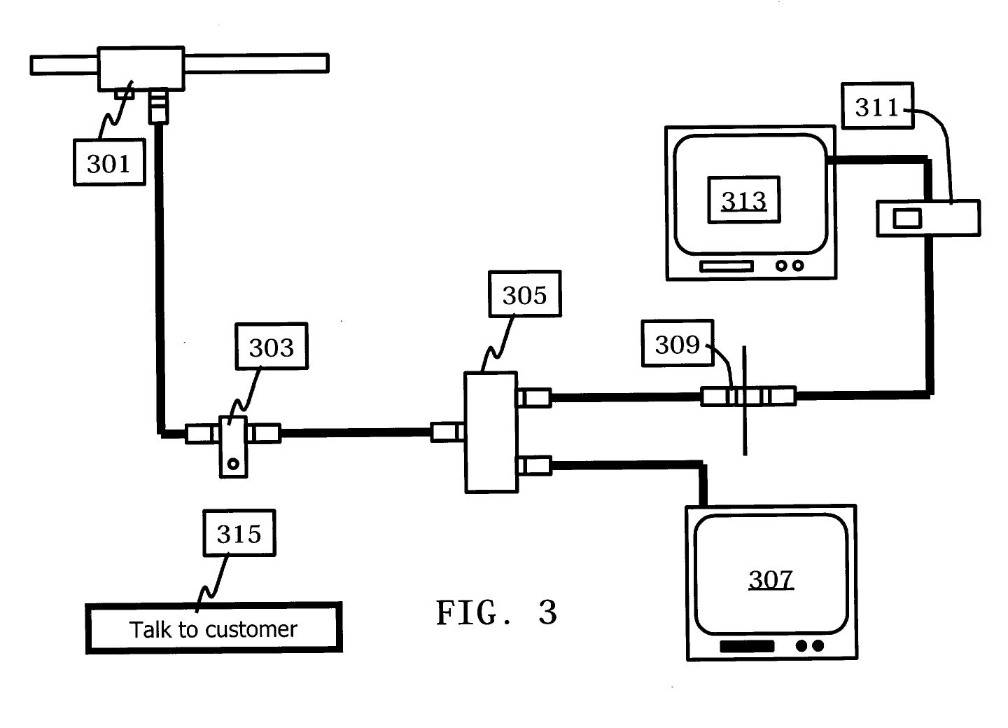

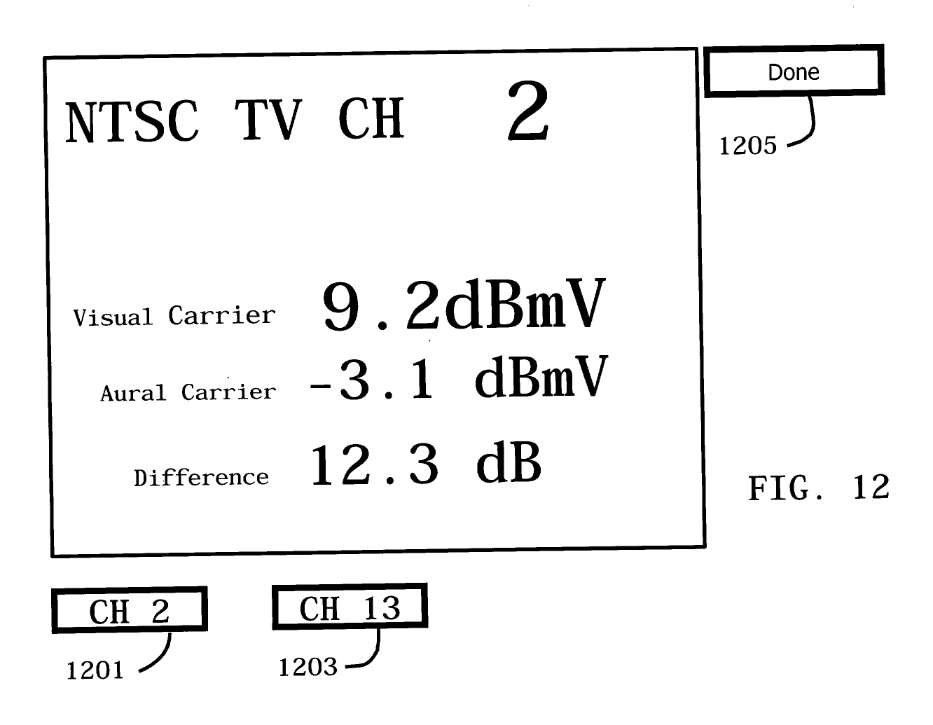

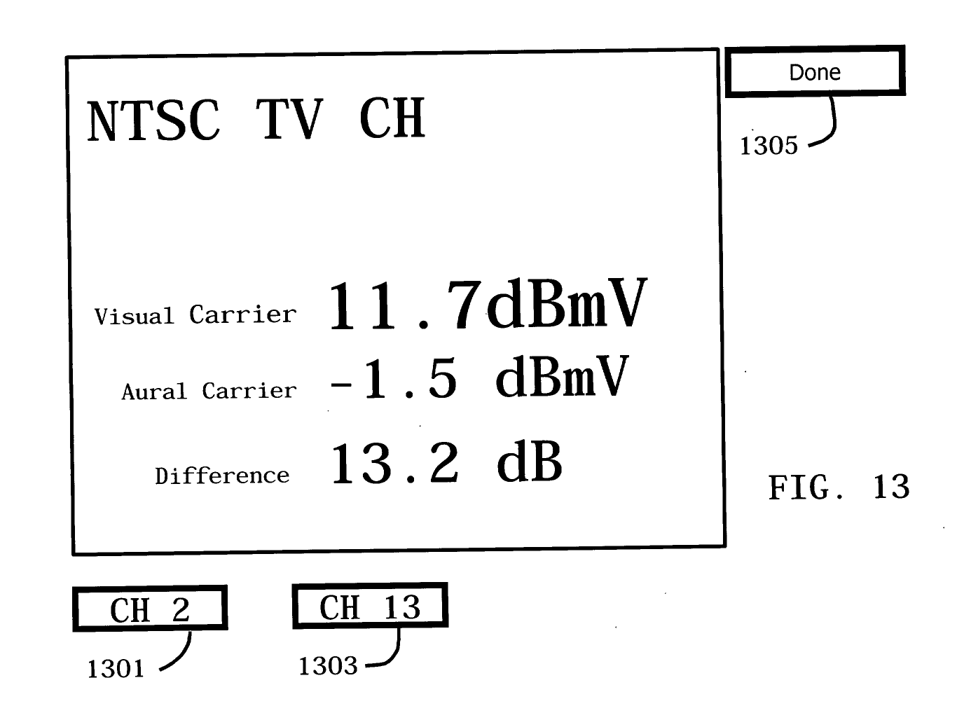

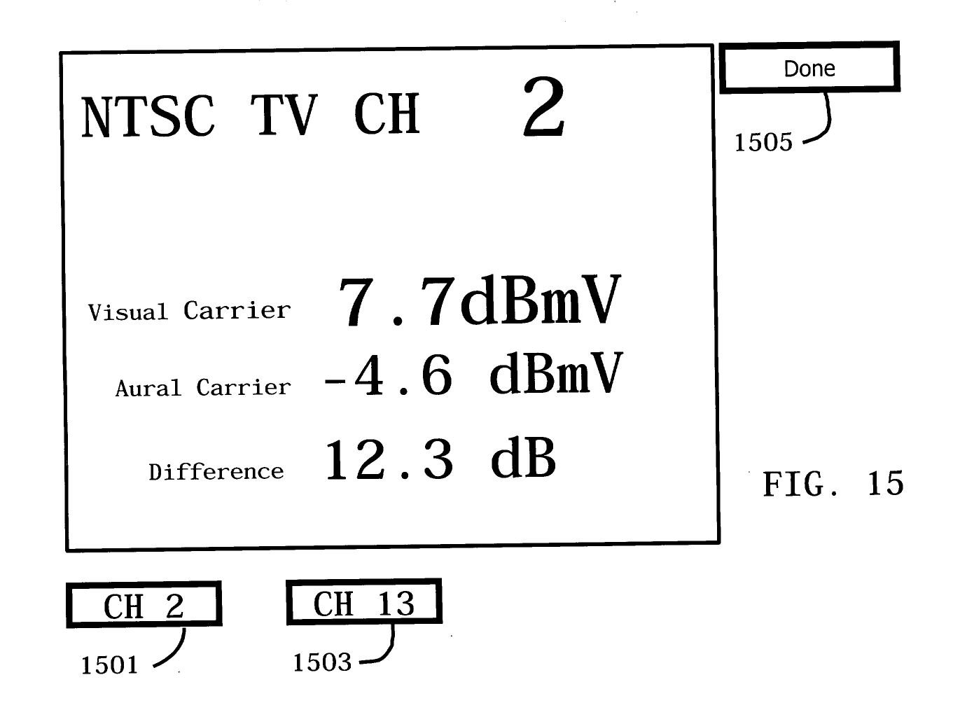

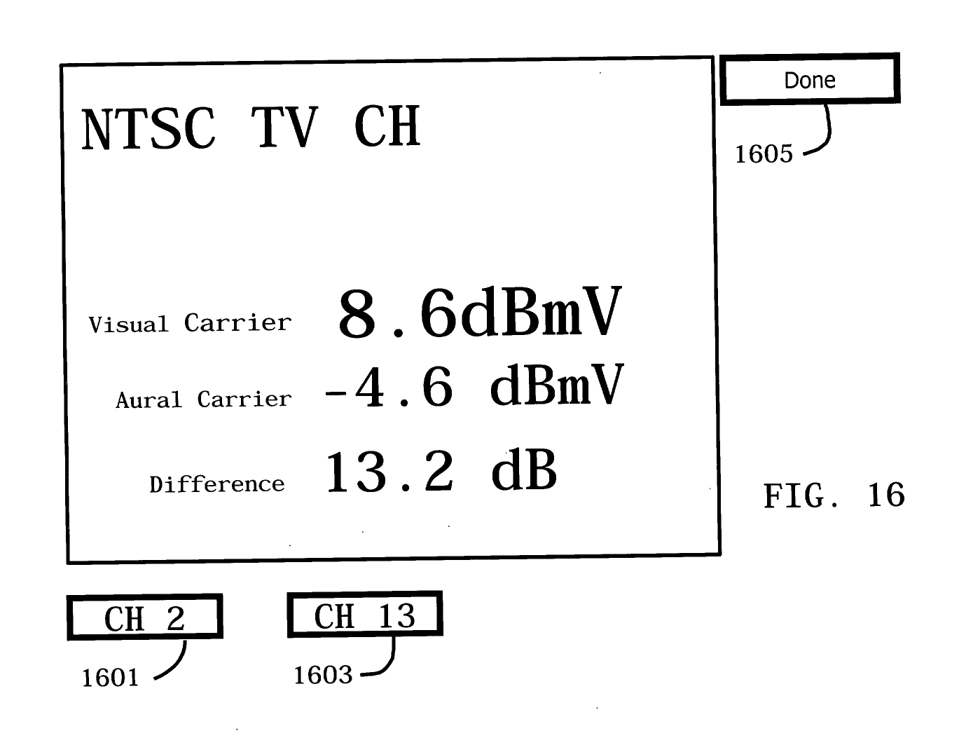

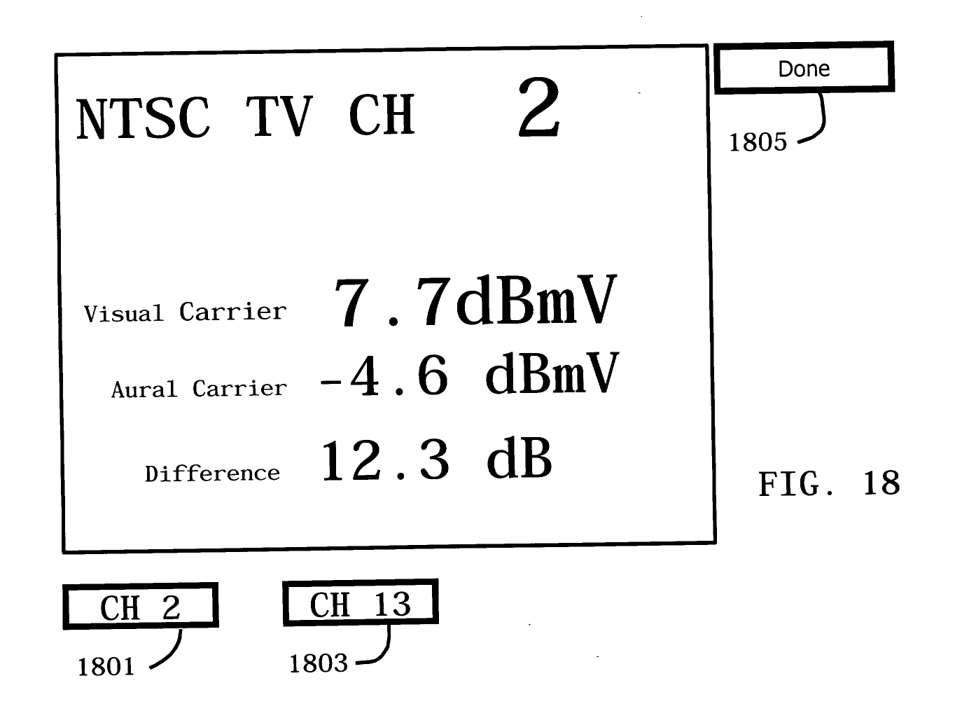

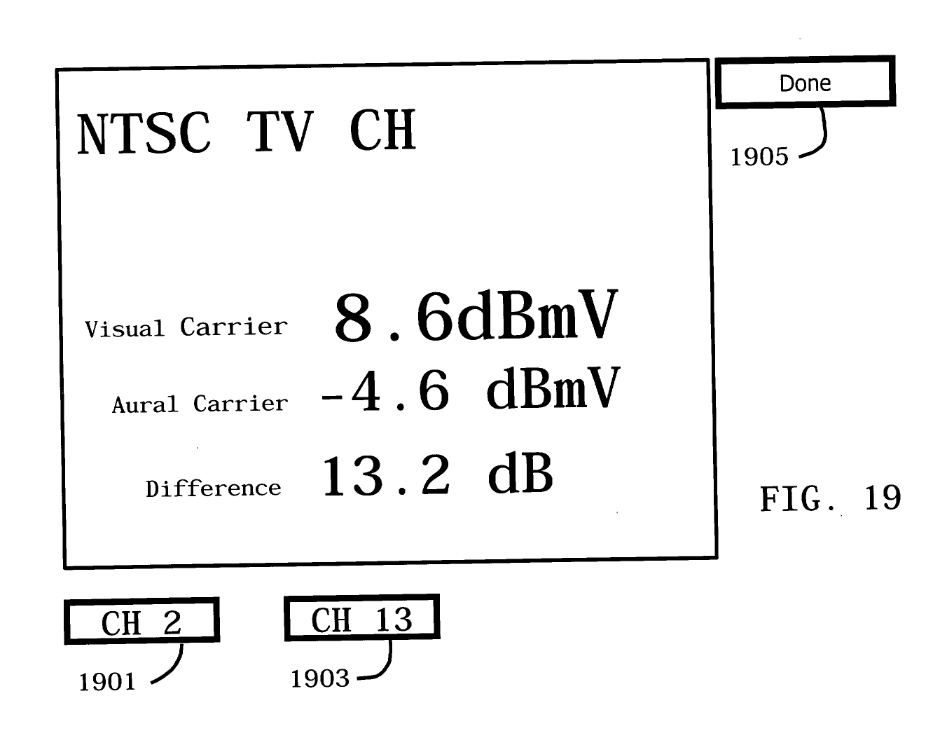

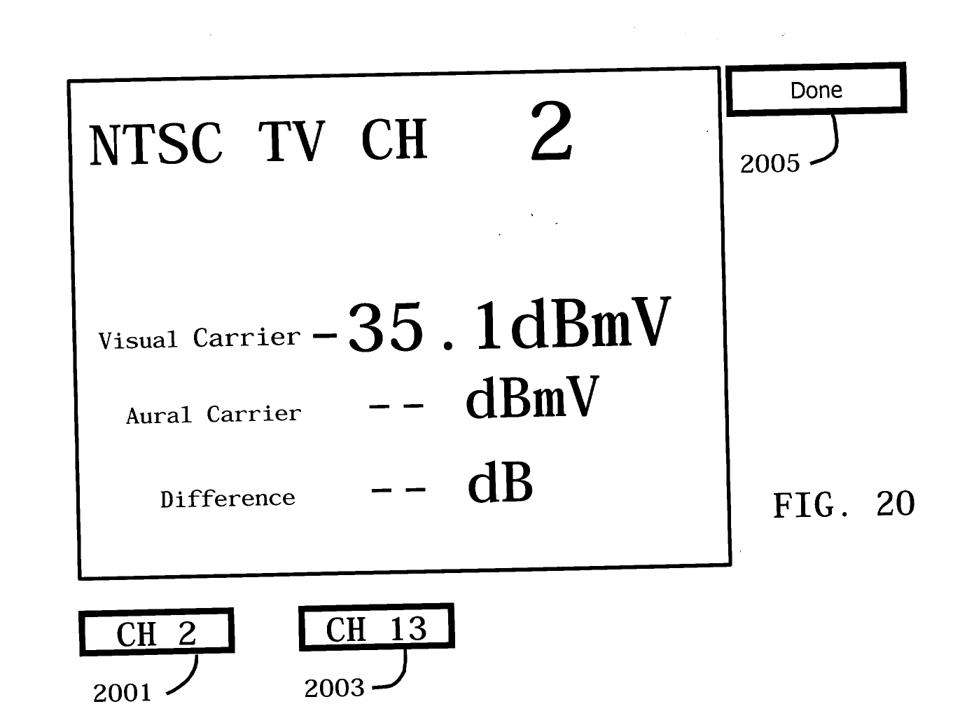

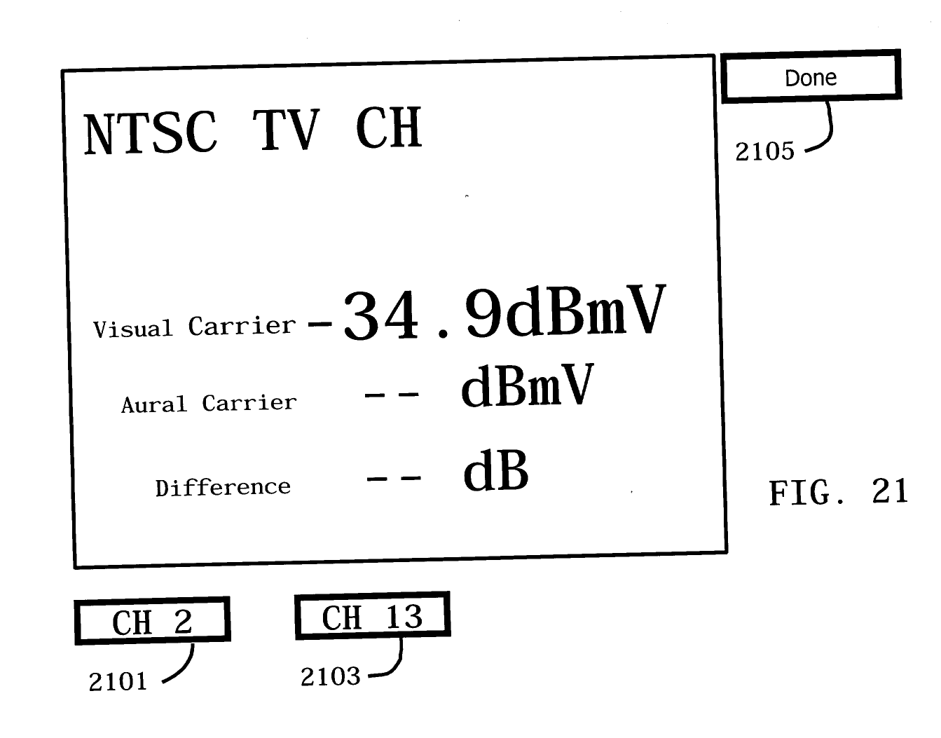

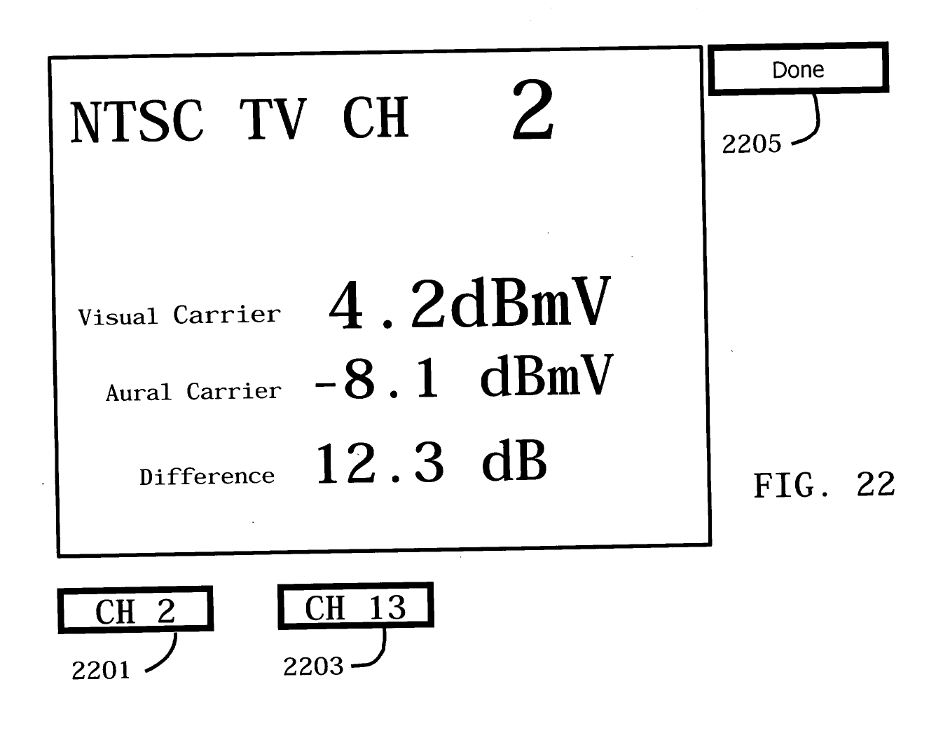

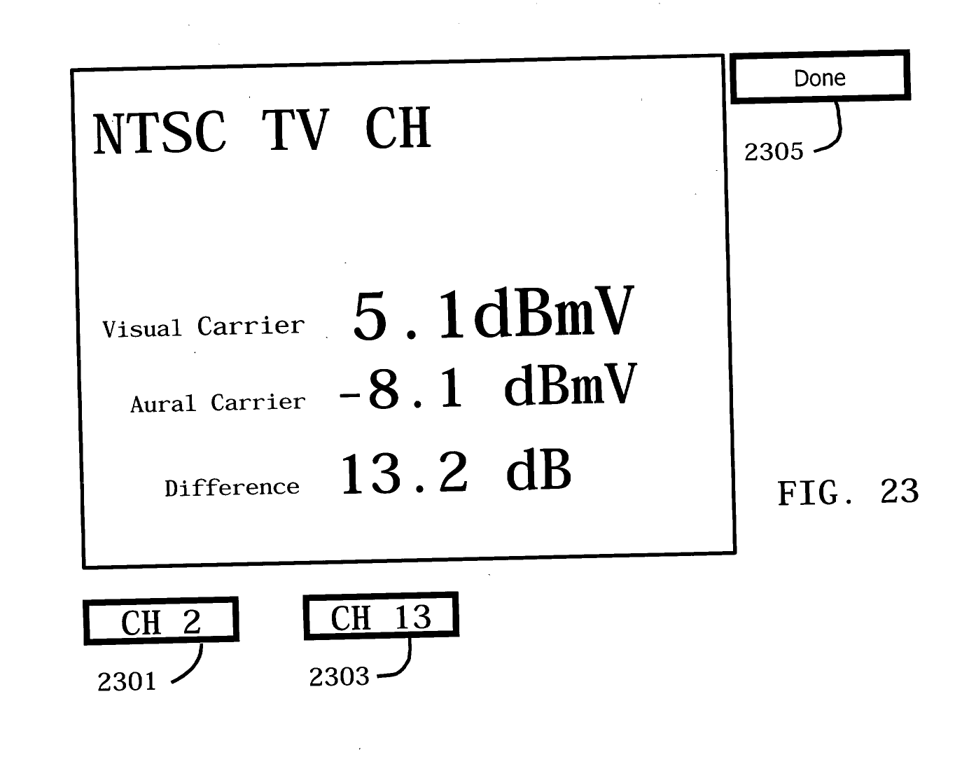

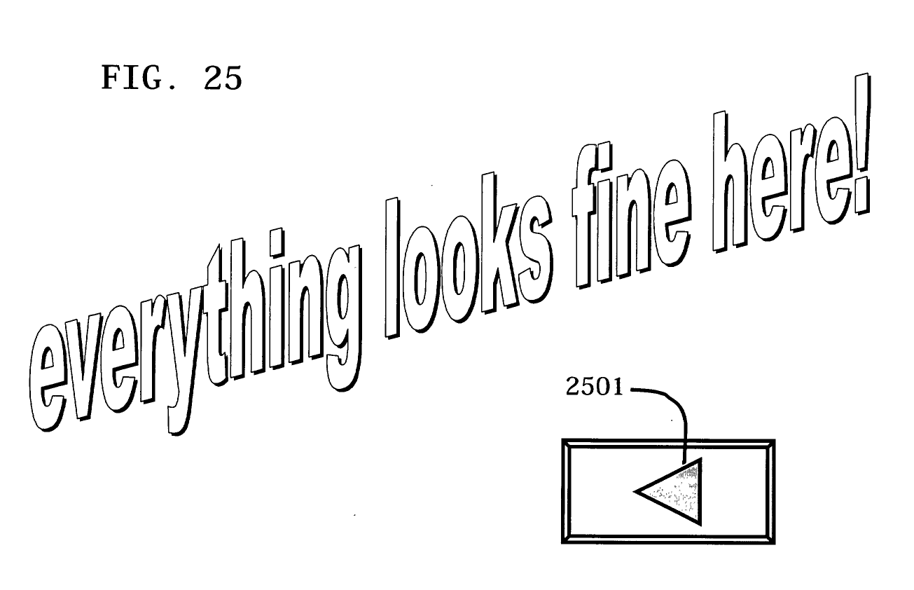

Many forms of graphic navigation are contemplated. A simple approach is to use ‘clickable’ graphic screens, rather than buttons or a command line. FIGS. 2-25 illustrate a house drop simulator subscriber location graphic interface using clickable graphic screens. FIG. 2 is an initial screen indicating that the user has arrived at the subscriber's house of a subscriber that has complained of “snowy pictures”. Clicking on a starting icon 201 leads the user to FIG. 3, which is a representative house block diagram of the network configuration at the subscriber location. The house block diagram includes several selectable graphics, including a subscriber tap icon 301, a ground block icon 303, a drop splitter icon 305, a first TV set icon 307, a connector icon 309, a set top box icon 311 and a second TV icon 313. The house block diagram also includes a selectable “Talk to customer” icon 315. In this case, selection of the “Talk to customer” icon 315 causes display of an “everything looks fine here!” graphic of FIG. 25, indicating that nothing new is learned from the subscriber and/or the subscriber is ok and not upset, etc. Of course, many alternative results may be presented at this point. The “everything looks fine here!” graphic includes a selectable return icon 2501, which returns the user back to the previously viewed display. It is noted that the “everything looks fine here!” graphic of FIG. 25 may be employed at various points in the program.

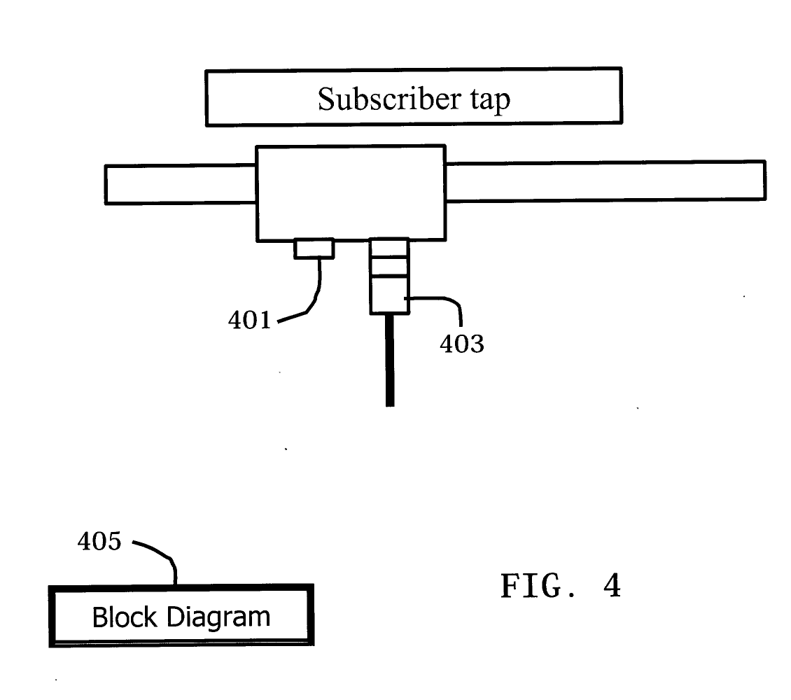

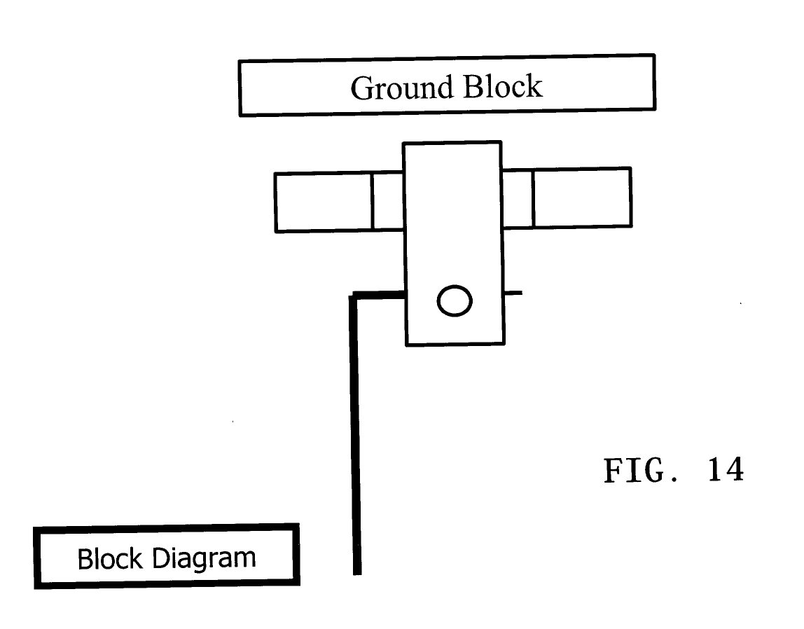

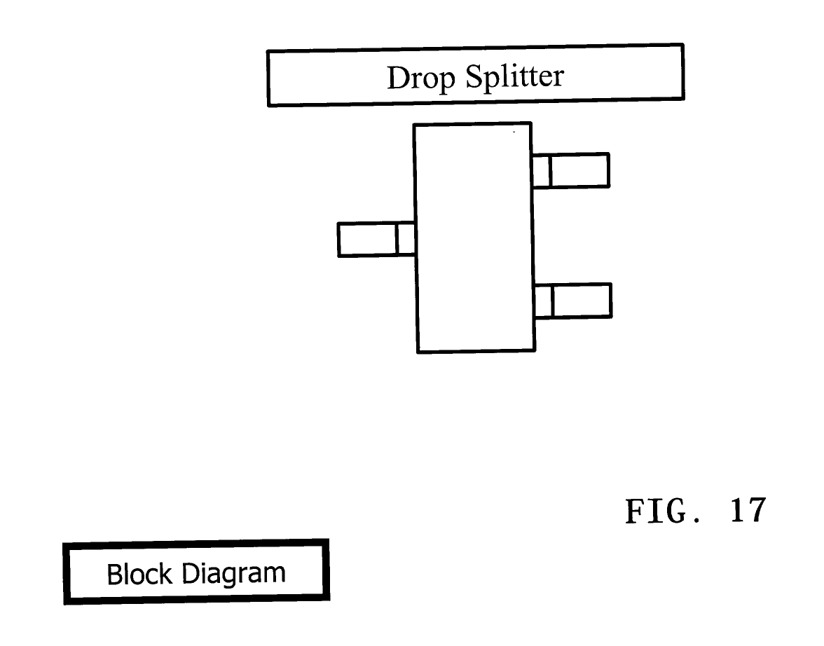

Selection of the subscriber tap icon 301 causes display of a subscriber tap block diagram of FIG. 4. Selection of the ground block icon 303 causes display of a ground block block diagram of FIG. 14. Selection of the drop splitter icon 305 causes display of a drop splitter block diagram of FIG. 17. Although not shown, selection of the first TV set icon 307, the connector icon 309, the set top box icon 311 or the second television icon 313 causes display of corresponding block diagrams and additional selection items. Selection of the connector icon 309 would cause display of a connector block diagram with selectable measurement and/or return buttons. Selection of the set top box icon 311 would cause display of a set top box block diagram, in which the user could change channels and make any of predetermined measurements. Selection of either of the television icons 307, 313 would display a television diagram with selectable options, such as television control adjustments, viewing of the TV screen, viewing the backside of the TV, etc. It is noted that it is not encouraged for a technician to adjust the subscriber's television, so that additional instructions, warnings or results may be displayed if the user attempts to do so. A screen shot illustrating what is displayed on the TV for various channels (assuming the TV is controlled by the subscriber), may help the user diagnose or verify the problem.

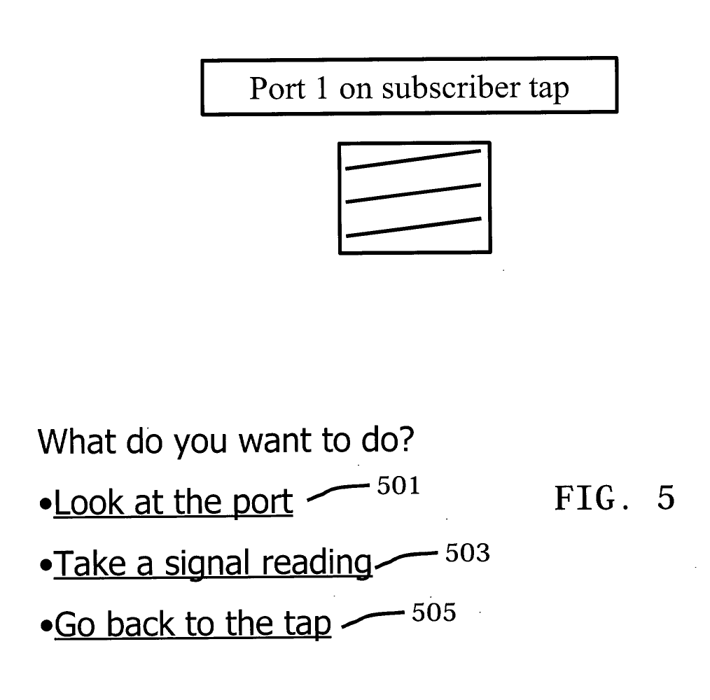

Selection of the subscriber tap icon 301 causes display of a subscriber tap block diagram of FIG. 4, which includes a selectable port 1 icon 401, an F connector icon 403 and a “Block Diagram” icon 405. Selection of the Block Diagram icon 405 returns the user to FIG. 3. Selection of the port 1 icon 401 causes display of FIG. 5, which is a block diagram of port 1 on the subscriber tap. The port 1 diagram includes three selectable options, including a “Look at the port” graphic 501, a “Take a signal reading” graphic 503 and a “Go back to the tap” graphic 505. Selection of the “Look at the port” graphic 501 causes display of the “everything looks fine here!” graphic of FIG. 25, indicating that the port looks good from a visual inspection. Selection of the “Go back to the tap” graphic 505 returns the user back to the subscriber tap block diagram of FIG. 4.

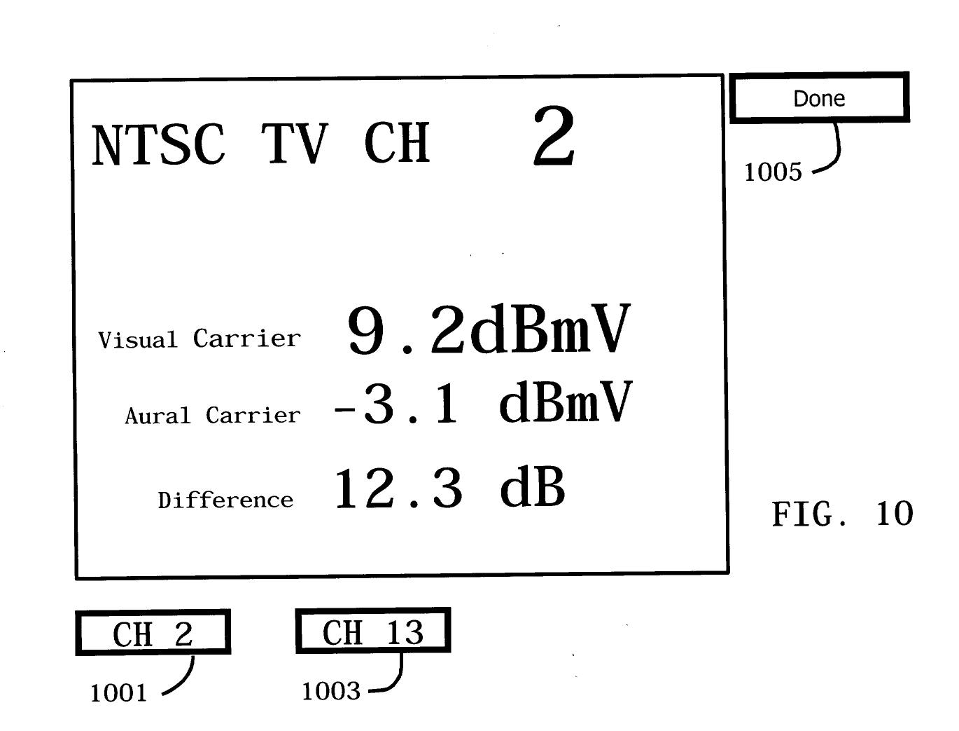

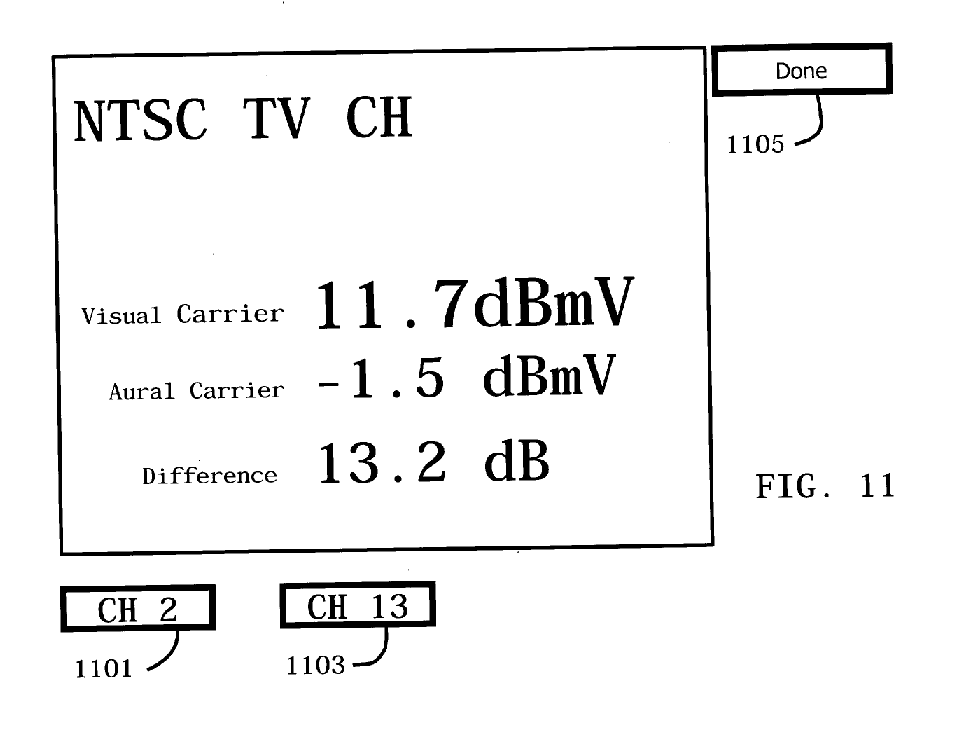

Selection of the “Take a signal reading” graphic 503 causes display of a meter display diagram illustrated in FIG. 10 for NTSC TV CH 2. The meter display of FIG. 10 is a generic meter representation including a “Visual Carrier” measurement, an “Aural Carrier” measurement, and a “Difference” measurement for NTSC TV CH 2, where each measurement includes a corresponding value (e.g., Visual Carrier=9.2 dBmV, Aural Carrier=−3.1 dBmV, and Difference=12.3 dB). The meter display of FIG. 10 also includes selectable channel icons including a “CH 2” icon 1001 and a “CH 13” icon 1003 and a selectable “Done” icon 1005. The CH 2 icon 1001 is a dummy icon in this case because the meter already displays the channel 2 reading. Selection of the CH 13 icon 1003 causes display of a meter display diagram illustrated in FIG. 11 for NTSC TV channel 13, which shows similar “Visual Carrier”, “Aural Carrier”, “Difference” measurements for channel 13 with corresponding (and different) values, and similar selectable channel icons including a “CH 2” icon 1101 and a “CH 13” icon 1103 and a selectable “Done” icon 1105. Selection of the CH 2 icon 1101 returns back to FIG. 10, and the CH 13 icon is a dummy icon since the channel 13 values are already displayed. Selection of either of the “Done” icons 1005 or 1105 returns the user back to the subscriber tap block diagram of FIG. 4. In this manner, the program has simulated the user taking measurements of port 1 of the subscriber tap.

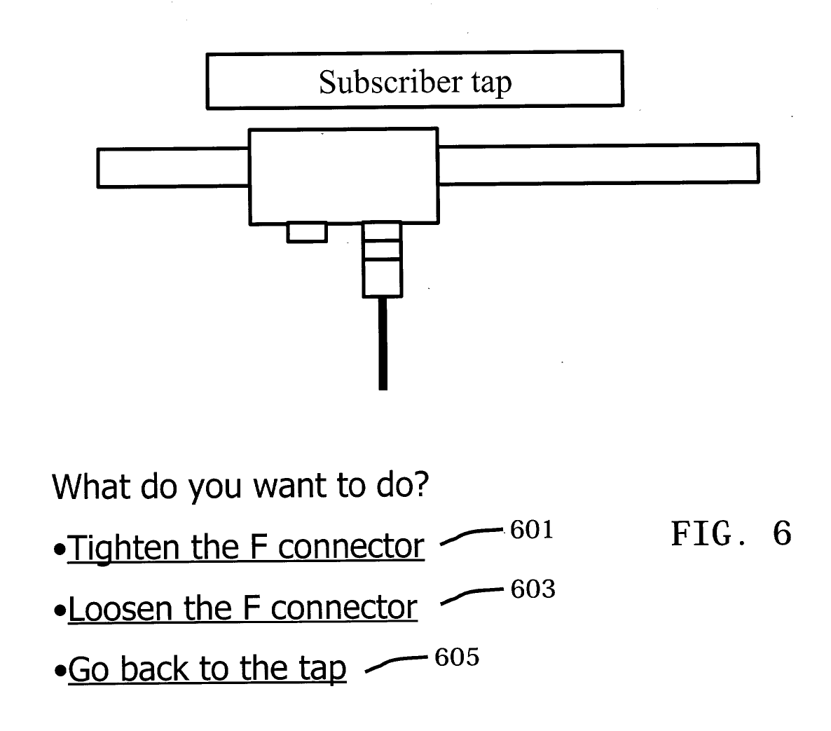

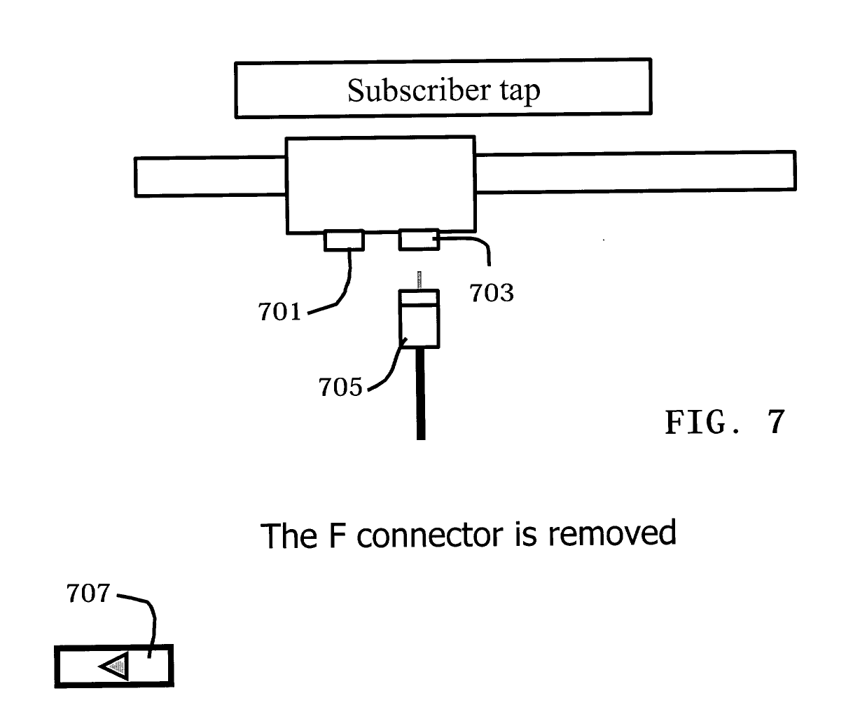

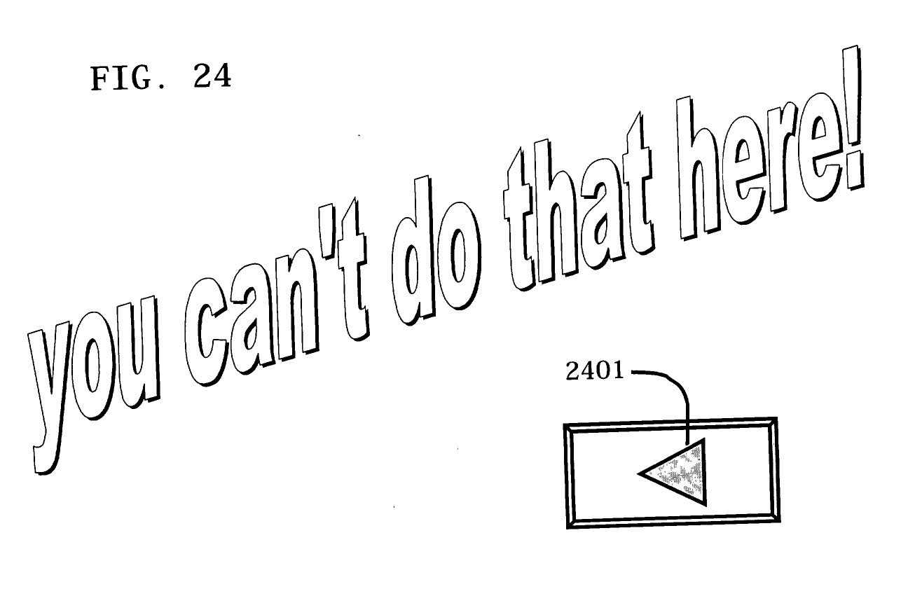

Referring back to FIG. 4, selection of the F connector icon 403 causes display of a similar subscriber tap block diagram of FIG. 6, which further includes three selections including a “Tighten the F connector” graphic 601, a “Loosen the F connector” graphic 603 and a “Go back to the tap” graphic 605. Selection of the “Go back to the tap” graphic 605 returns the user back to the subscriber tap block diagram of FIG. 4. Selection of the “Tighten the F connector” graphic 601 causes display of a “you can't do that here!” graphic of FIG. 24, indicating that the attempted action is not allowed or would not be proper. The “you can't do that here!” graphic includes a selectable return icon 2401, which returns the user back to the point of entry. It is noted that the “you can't do that here!” graphic of FIG. 24 may be employed at various points in the program. Selection of the “Loosen the F connector” graphic 603 causes display of a subscriber tap block diagram of FIG. 7 in which the F connector is shown as being removed.

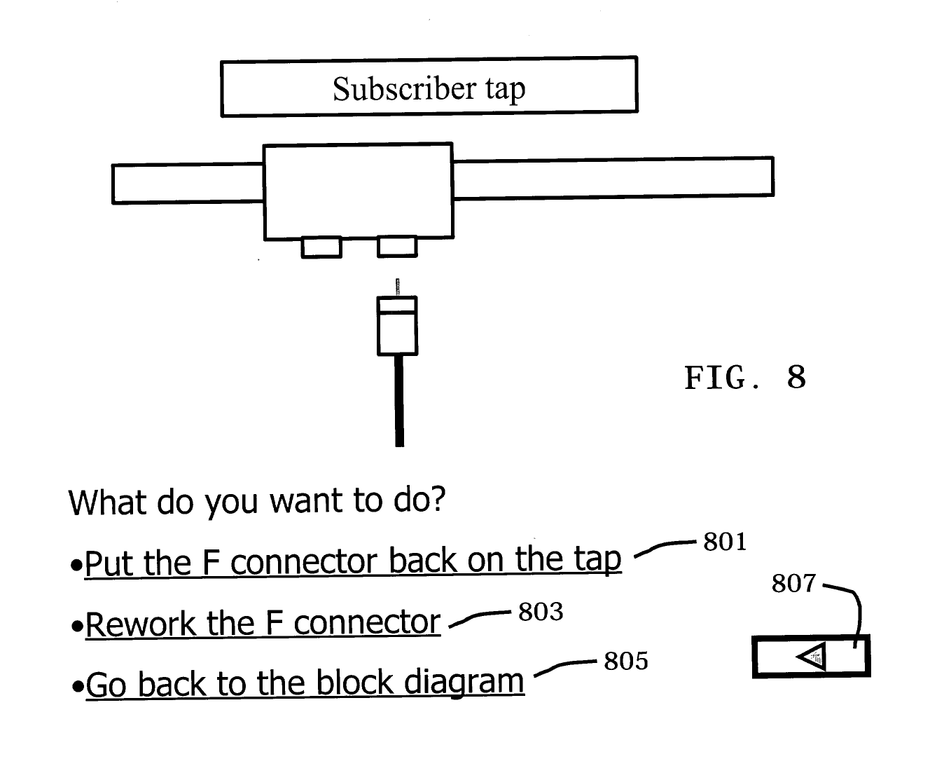

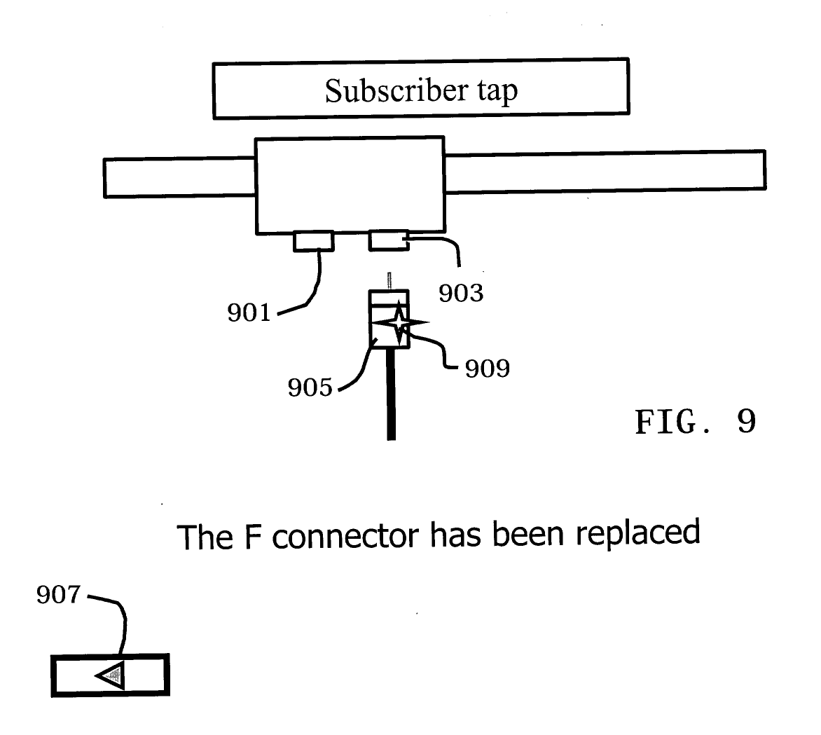

The subscriber tap block diagram of FIG. 7 includes several selectable icons including a port 1 icon 701, a port 2 icon 703, an F connector icon 705 and a return icon 707. Selection of either of the port 1 or port 2 icons 701, 703 causes display of the same or a similar port block diagram shown in FIG. 5 so that the user may make similar channel measurements previously described. For example, the user may take measurements of port 1 if not already made and may make new or additional measurements of port 2 with the F connector removed for comparison. Selection of the return icon 707 returns to the previously viewed display in the event the user wants to return or changes his/her mind. The return icons in each display operate in the same or similar intuitive manner. Selection of the F connector icon 705 causes display of a similar subscriber tap block diagram of FIG. 8, which further includes three selections including a “Put the F connector back on the tap” graphic 801, a “Rework the F connector” graphic 803, a “Go back to the block diagram” graphic 805 and a return icon 807. Selection of the “Go back to the block diagram” graphic 805 returns the user to the house block diagram of FIG. 3. Selection of the “Put the F connector back on the tap” graphic 801 returns the user to the subscriber tap block diagram of FIG. 4. Selection of the “Rework the F connector” graphic 803 causes display of a similar subscriber tap block diagram of FIG. 9 in which the F connector has been replaced as indicated by a completion star graphic 909 and/or descriptive text. The subscriber tap block diagram of FIG. 9 also includes port 1 and 2 selectable icons 901, 903 for the user to make similar readings as previously described. The subscriber tap block diagram of FIG. 9 further keeps the selectable F-connector icon 905, which returns the user back to subscriber tap block diagram of FIG. 8 for similar options including putting the F connector back onto the tap and a return icon 907 which returns the user to the previously viewed display.

Similar actions may be taken by the user with reference to the ground block, the drop splitter, other connectors, the set top box, the subscriber televisions, etc. and will not be further described. In this manner, the user may peruse the subscriber's network configuration, make measurements of various components in the network, and ultimately identify and fix the problem. In this case, rework or replacement of the F connector of the subscriber tap resolved the problem. It is noted that this is a very simplified example and that many complexities are incorporated into the program for a more realistic virtual experience. For example, if the user fails to re-connect the reworked F connector and jumps to another location for measurement, the program detects the disconnected F connector and causes corresponding measurements. Either of the TV's would indicate loss of signal, and the user is tasked to recall and re-connect the F connector for proper operation.

The tech trainer incorporates many problems and situations that may be programmed in and randomly produced during each session or selectively programmed by an administrator. The tech trainer may incorporate any list of tools for use by the technician in training, including tool belt, meters (FSM or the like), ladder, safety belt, ladder(s), climber(s), hard hat, etc. The tech trainer incorporates settings and readings of devices or test equipment, such as cable box settings (on/off, channel selections, etc.), television settings (On/off, off-air/cable, channel settings, etc.), FSM settings/readings (On/off, battery test, channel settings, etc.), subscriber house locations including front of house (front door, etc.), various back of house items and locations, including pole, tap, drop, ground block and splitter(s), living room (LR) (wall plates [front and back], cable box [front and back], main TV [front and back]), master bedroom (MBR) TV [front and back], etc. The tech trainer provides options for taking measurements at various locations, such as used or unused taps, ground block input or output, male or female F connectors with or without jumpers, splitter input or output, male or female F connectors with or without jumpers, and connectors at various locations (living room, bedroom, master bedroom, etc.). The tech trainer includes user options for inspection, such as tap w/drop connected, F connector at tap, ground block intact, F connector into ground block, F connector out of ground block, ground block input side, ground block output side, splitter intact, F connector into splitter, F connector out of splitter top port, F connector out of splitter bottom port, splitter input port, splitter top output port, splitter bottom output port, wall plate front/back, cable box intact, F connector into/out of cable box, TV set intact, F connector into TV, port on TV, etc. The tech trainer incorporates options for replacement or rework, such as tap faceplate (same or different value), F connector at tap, drop between tap & ground block, F connector at ground block input or output, drop between ground block and splitter, F connector at splitter input or output (top or bottom port), drop between splitter output top port & MBR TV, drop between splitter output bottom port & LR wall plate, wall plate F 81, drop between wall plate and cable box, drop between cable box & TV, F connector at MBR TV, F connector at LR wall plate input or output, F connector at LR cable box input or output, F connector at LR TV, etc.

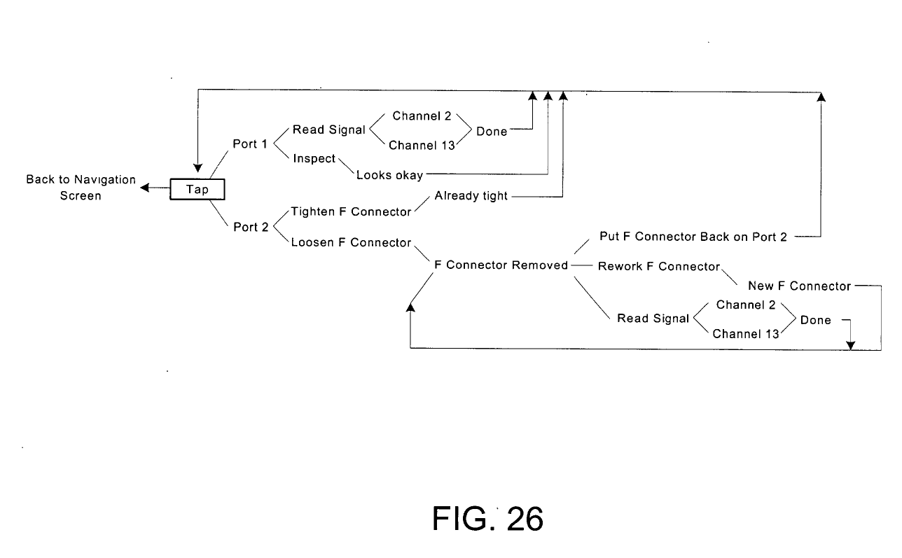

FIG. 26 is an exemplary flow diagram illustrating basic logical flow for a two-port tap. This embodiment is simplified and does not include swapping the faceplate or the like, but illustrates general principles. Port 1 is empty and port 2 has a drop on it.

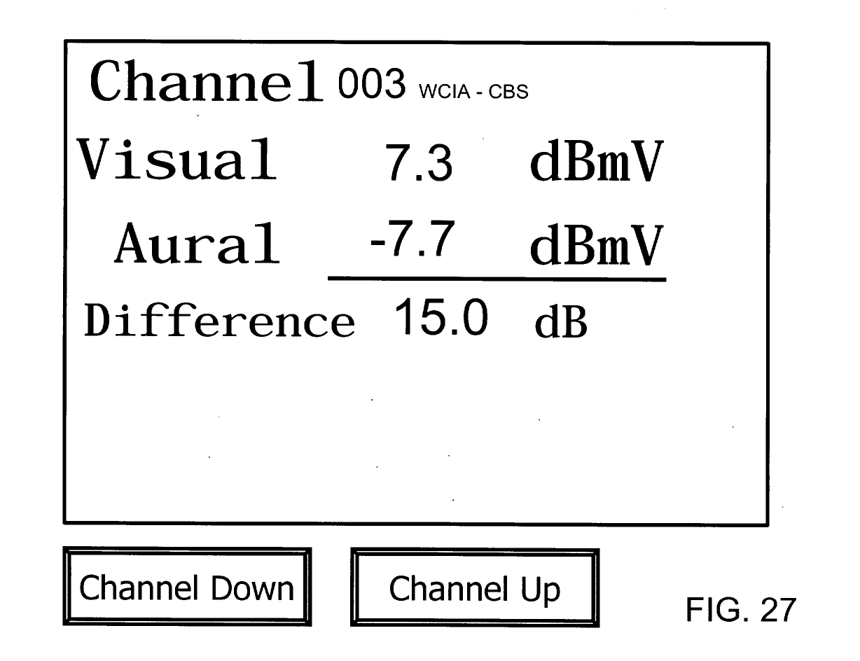

The tech trainer incorporates test equipment modules for enabling the user to virtually display, set up and use measurement equipment during a session. In one embodiment, interactive pictures and the like of actual equipment may be employed to facilitate familiarization with specific or commonly-used equipment. Alternatively, rather than teach the users to use any specific make/model of test equipment, the tech trainer includes virtual generic test equipment which has all the features and functions that are commonly available. FIG. 27 is a screen shot of an exemplary virtual meter that is employed for making measurements at appropriate locations in the network. The user selects a tap or port for making the measurement, selects a meter icon or graphic and the virtual meter is displayed. In this case, the user may step through the channels using the “Channel Down” and “Channel Up” virtual buttons and read the values associated with the “Visual”, “Aural” and “Difference” measurements.

Similar concepts are applicable to other types of equipment, such as a spectrum analyzer or an oscilloscope or any other X Y plot devices. The tech trainer program determines what type of signal(s) are present, what levels are present, and what settings the equipment is using. The displays are drawn by the subroutine as needed. The use of virtual equipment is superior than providing ‘real world’ dummy display graphics since such the virtual equipment can display virtual measurements of the virtual environment to assist the user to diagnose a virtual problem.

Real-world samples may be incorporated into the tech trainer as well. Although the greatest flexibility is achieved through software generated situations, there are at least two types of real-world data that is included in the program, including digital photographs and digitized clips (MPEG or the like). Digital representations (e.g., photographs) are provided for such things as actual cable, drop components, or network components for visual training. Such photos are desired for the ‘inspect’ options throughout the simulator. Examples of digitized clips include customers interacting with the technician, TV pictures of any type of problem to be encountered, sounds of any type of problem to be encountered. The digitized clips are presented at appropriate times during each training session to enhance the training experience.

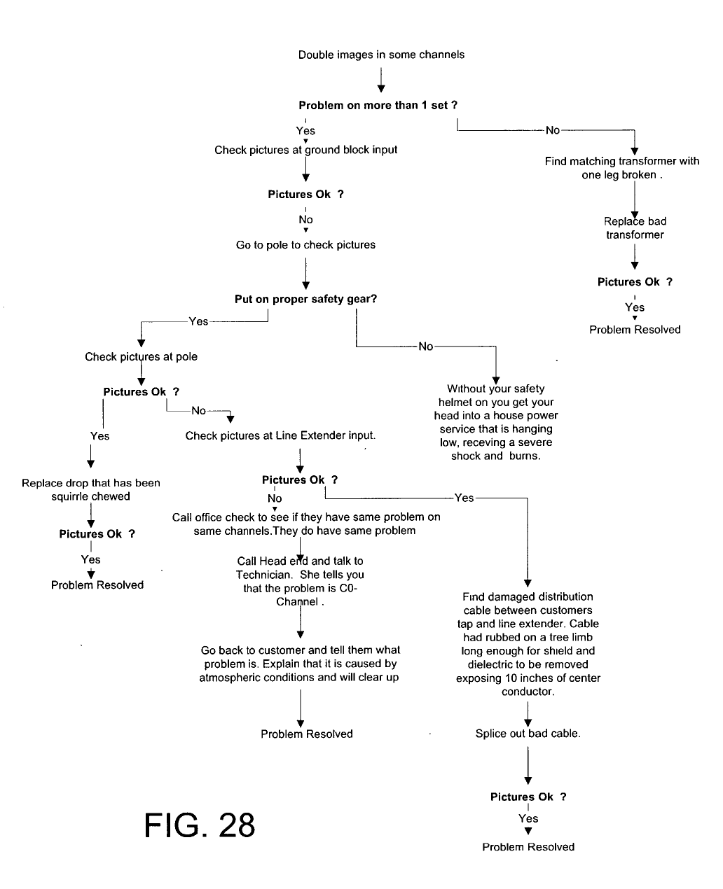

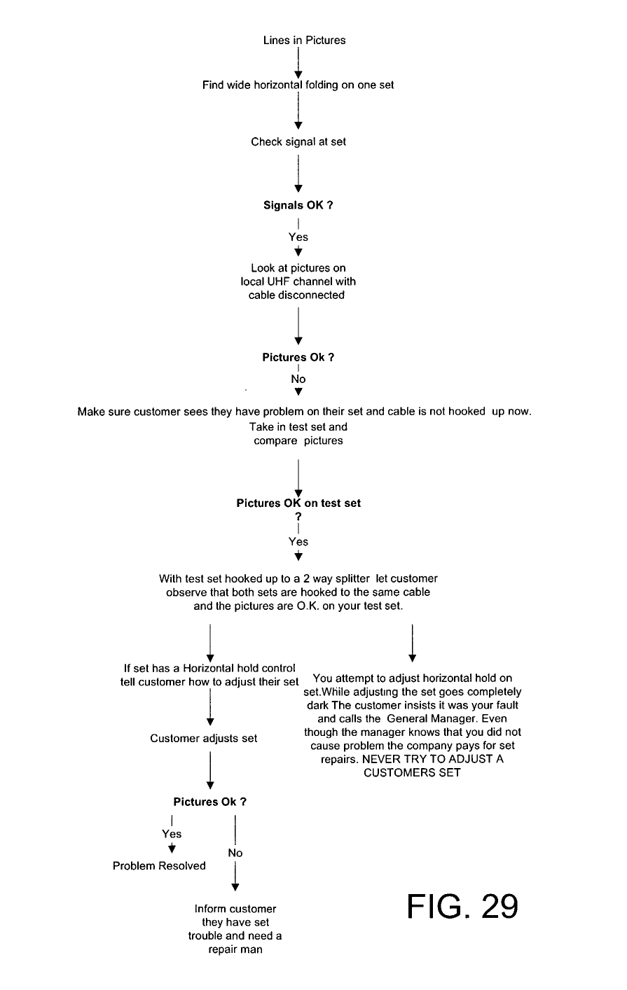

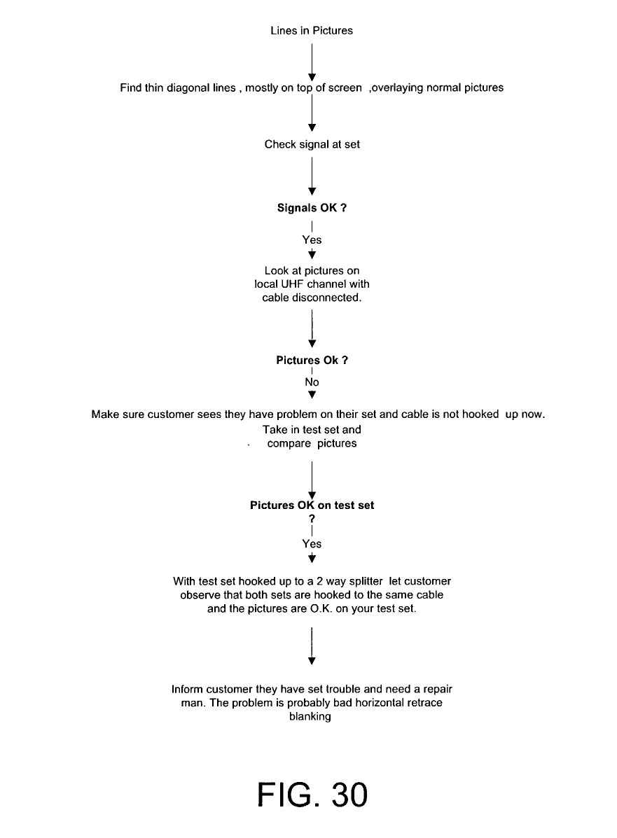

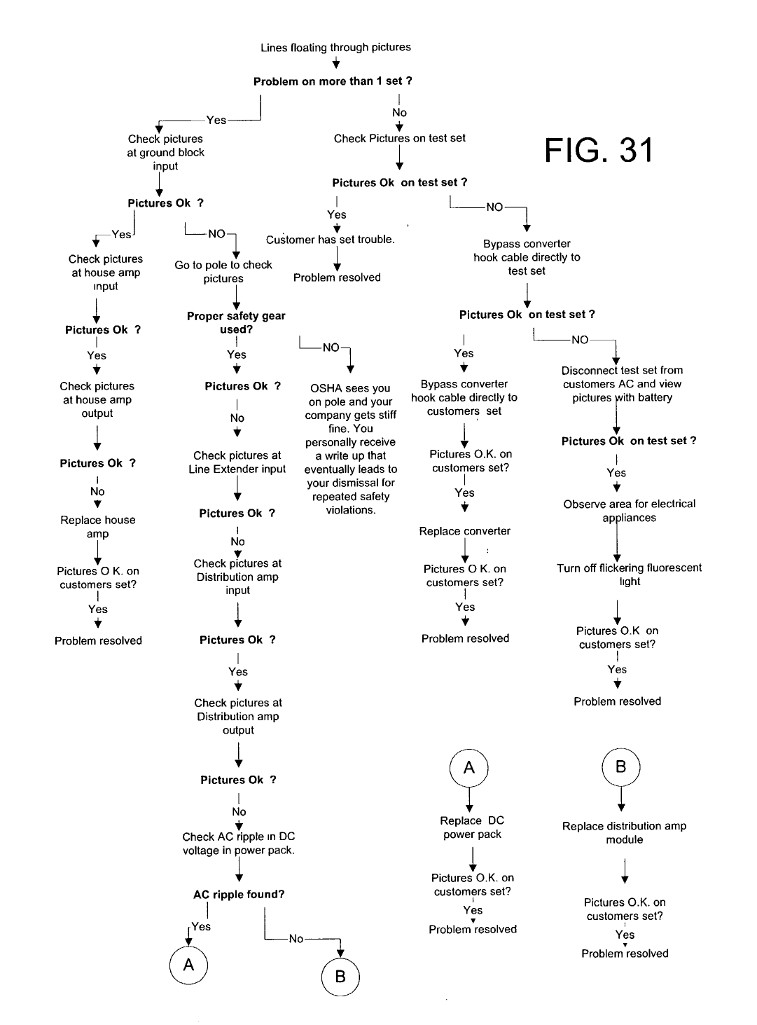

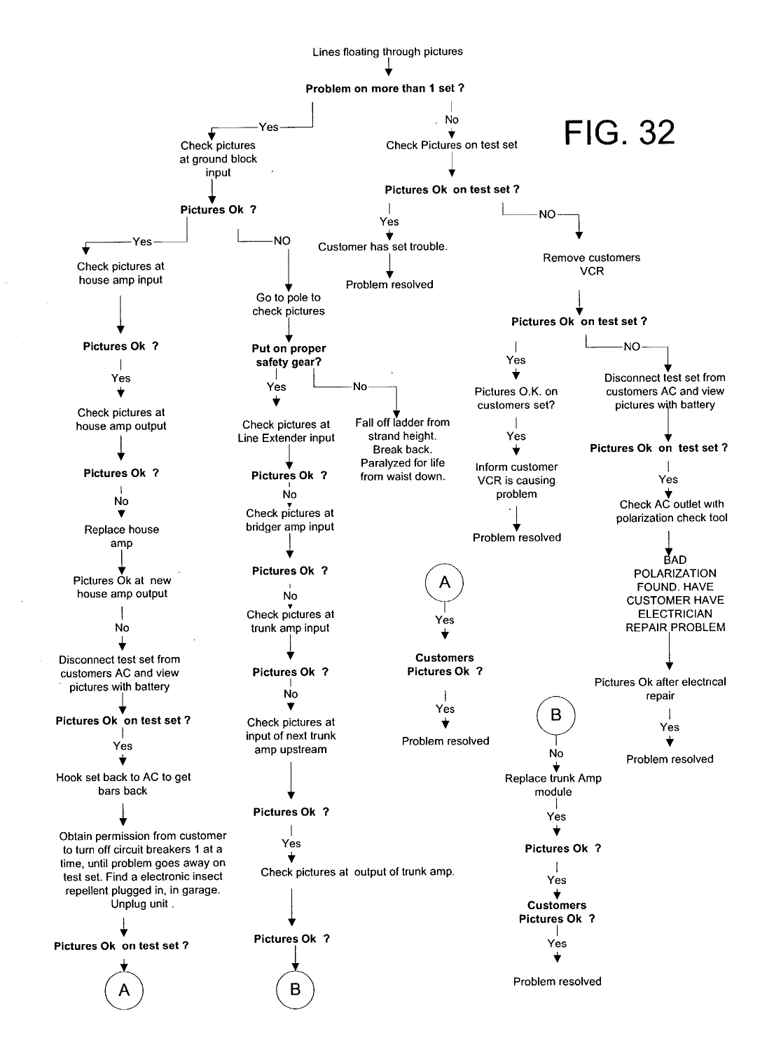

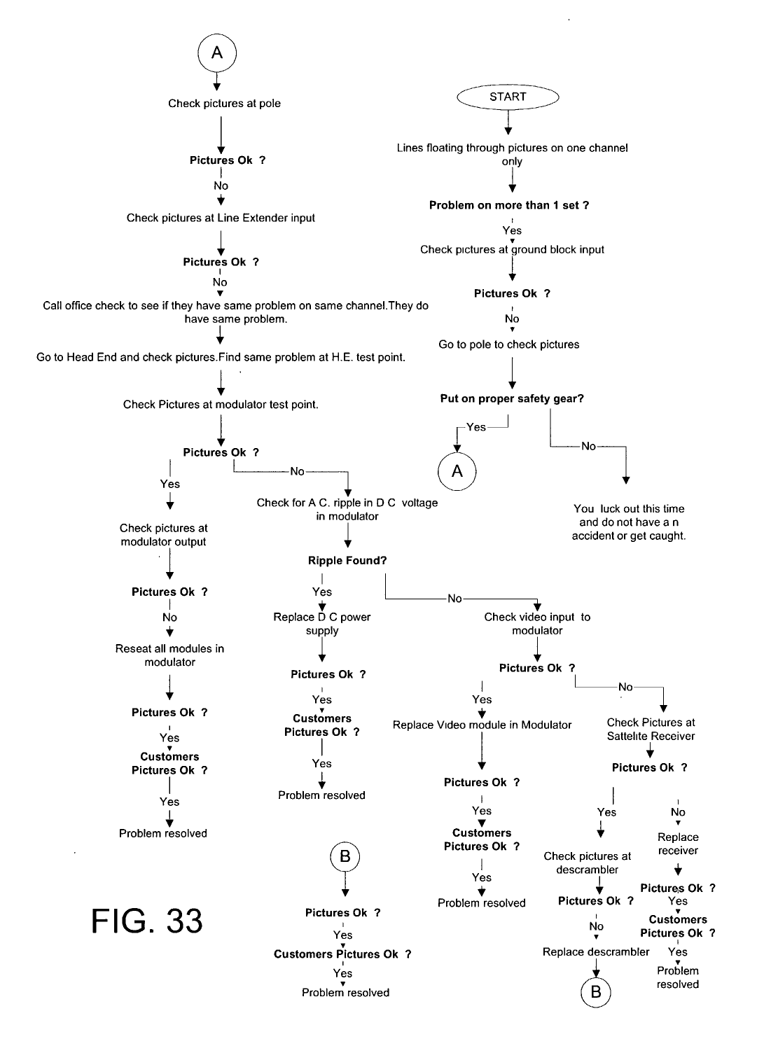

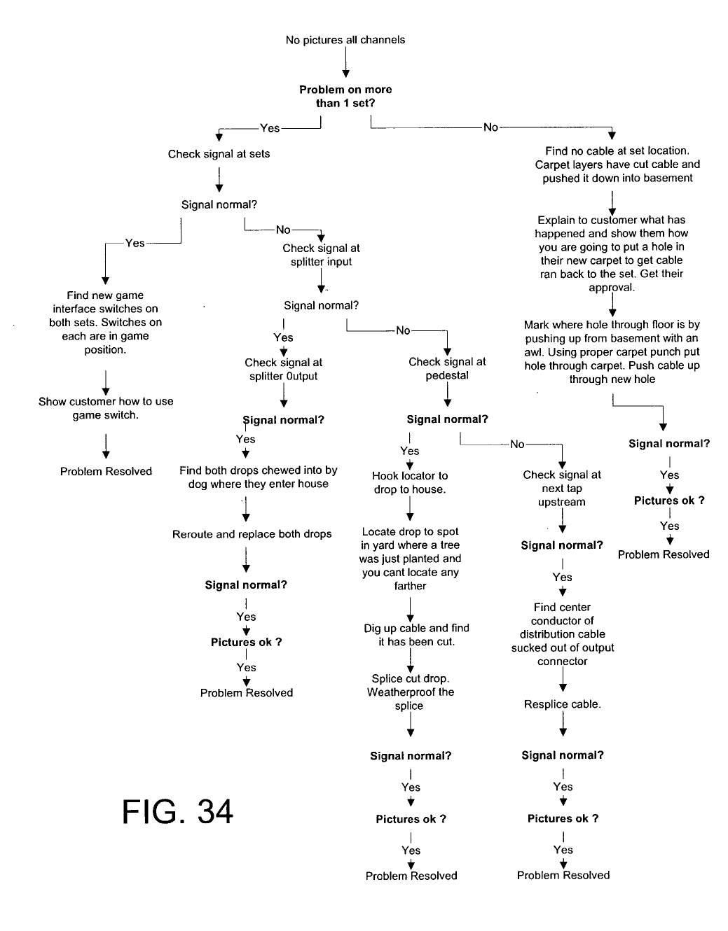

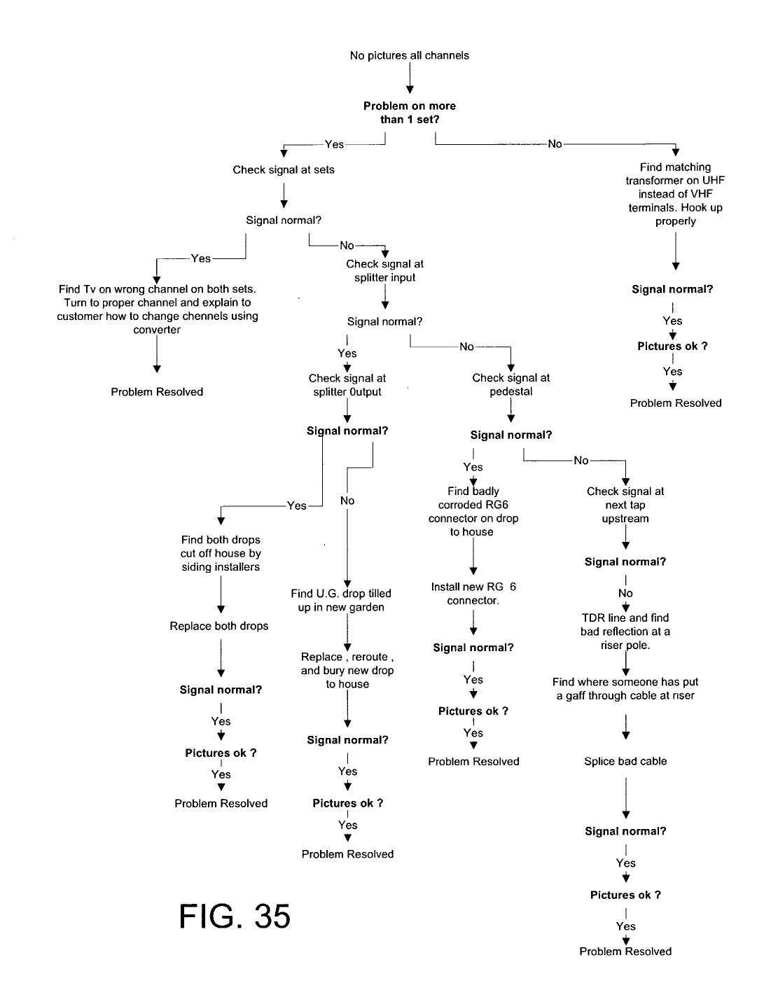

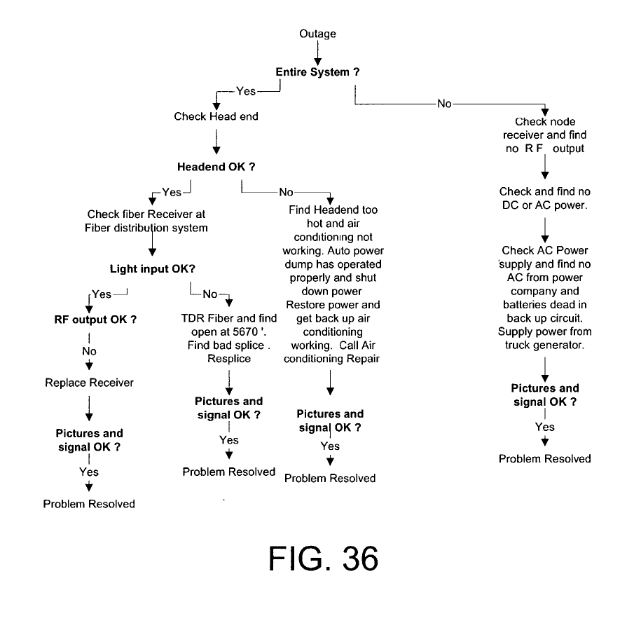

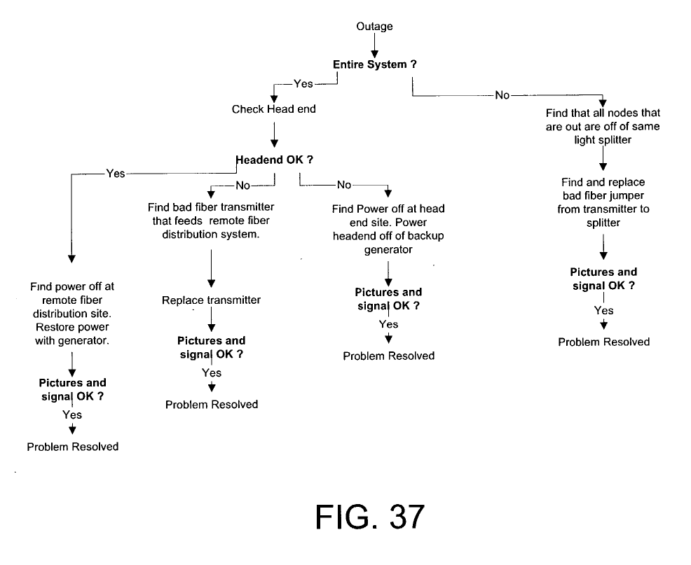

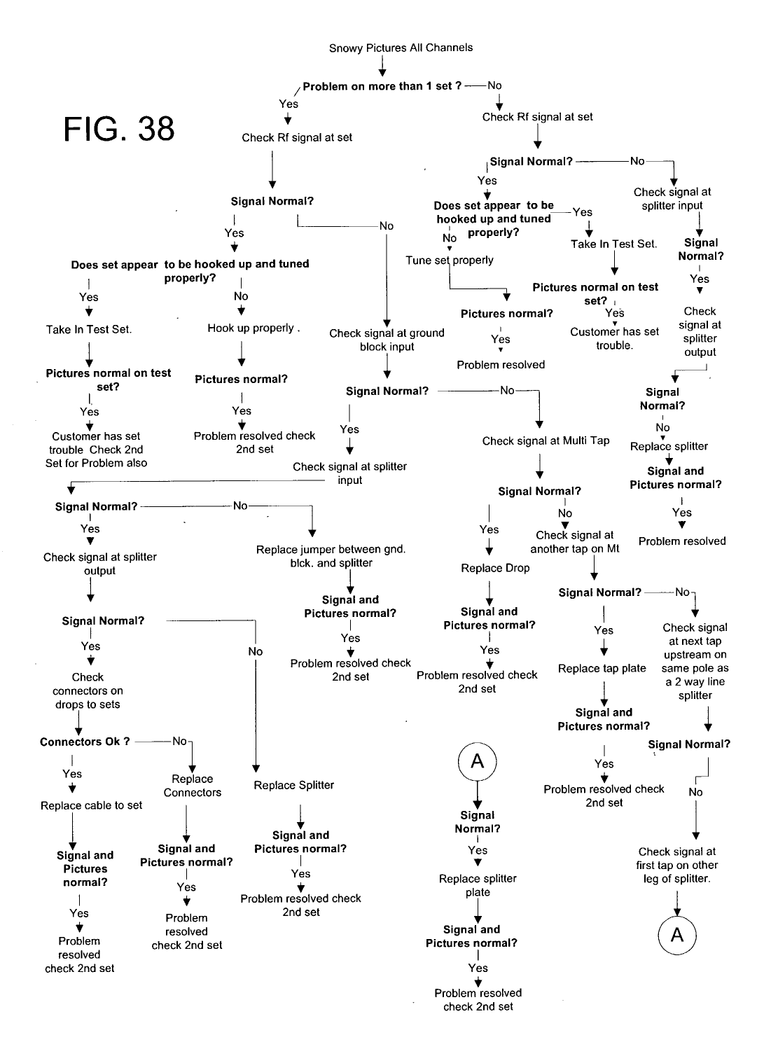

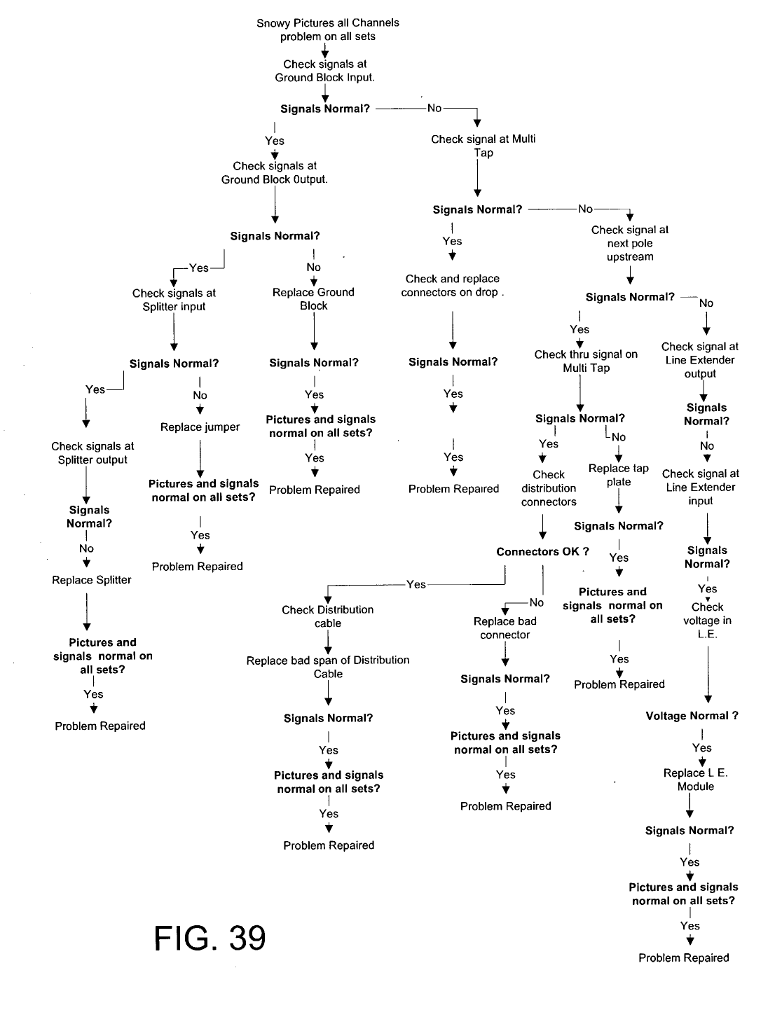

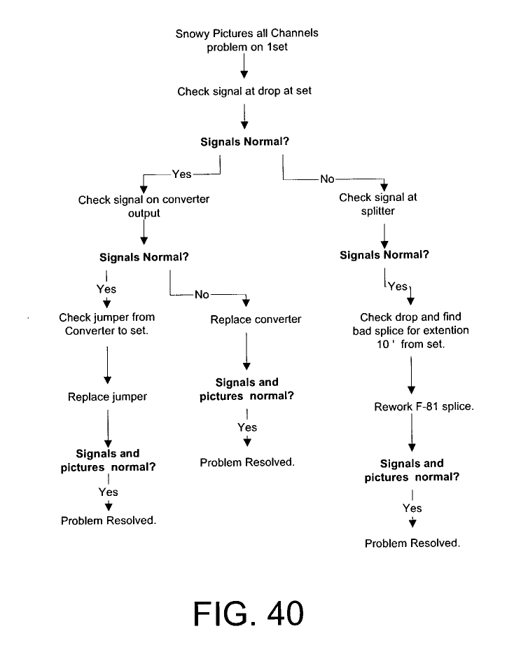

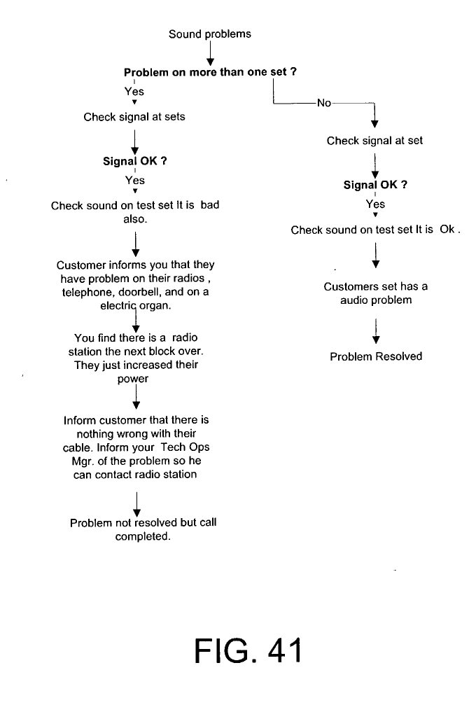

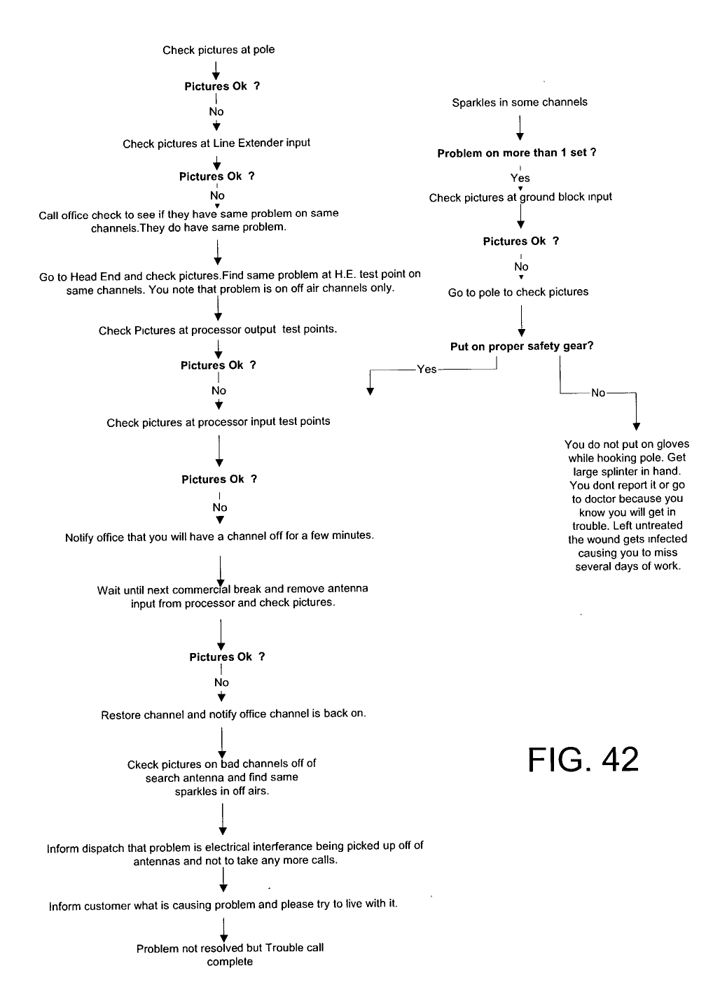

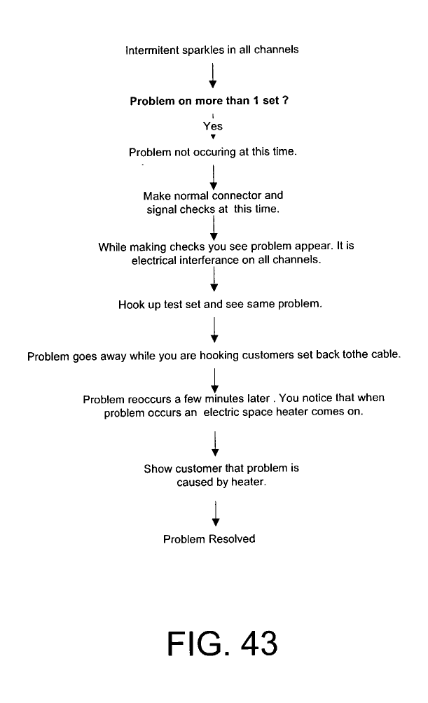

FIGS. 28-43 are flow diagrams illustrating procedural aspects associated with actual scenarios programmed into the tech trainer simulator. The actual scenarios include double images (FIG. 28), Horizontal lines (FIGS. 29 and 30), Lines floating through the pictures (FIGS. 31, 32, 33), No picture (FIGS. 34 and 35), Outages (FIGS. 36 and 37), Snowy pictures (FIGS. 38, 39 and 40), Sound problems (FIG. 41), Sparkles in picture (FIGS. 42 and 43), etc. Each flow diagram illustrates the steps the user should take to solve each indicated problem. The tech trainer, however, includes many options at each step so that an untrained technician could take any number of improper or unnecessary steps before arriving at the appropriate solution (or that may prevent solution). Iteration by the user through multiple sessions eventually teaches the user to follow the proper steps and to avoid unnecessary or improper procedures.

The tech trainer incorporates problems and solutions associated with various parts of the network, including headend related (antenna system, microwave system, TVRO receivers, modulator, demodulator, processor, signal switching, other), power outage of the power company, network related problems (AC power supply, pole, pedestal, cable, lashing, strand, connectors, node module, amplifier module, bridger module, return module, AGC module, filter module, pad, equalizer, amp splitter, amp chassis, amp power pack, amp housing, line splitter, line directional coupler, ground, power combiner, tap, fuse), drop related problems (cable, connector, trap, ground, ground block, splitter, other), house related problems (cable, connector, outlet, transformer, converter, VCR kit, A/B switch, other), customer-related problems (TV set, fine tuning, VCR, game switch, AC power, converter, A/B switch, other) and other, non-productive matters (checked outside—OK, no problem found, disconnect error, cancellations [at door or by phone], no access, etc.).

An exemplary “Lines in Picture” problem may include horizontal, diagonal and/or vertical aspects. The horizontal aspects may include AC hum (wall plug polarization, bad cable box, line extender, network amplifier), AC sparkles (antenna interference at headend, electrical interference at house), retrace lines (TV needs to be repaired/replaced), horizontal folding (horizontal hold needs to be adjusted, TV needs to be repaired/replaced), TV setup (setup switch flipped, no vertical in TV), line pairing (co-channel), etc.

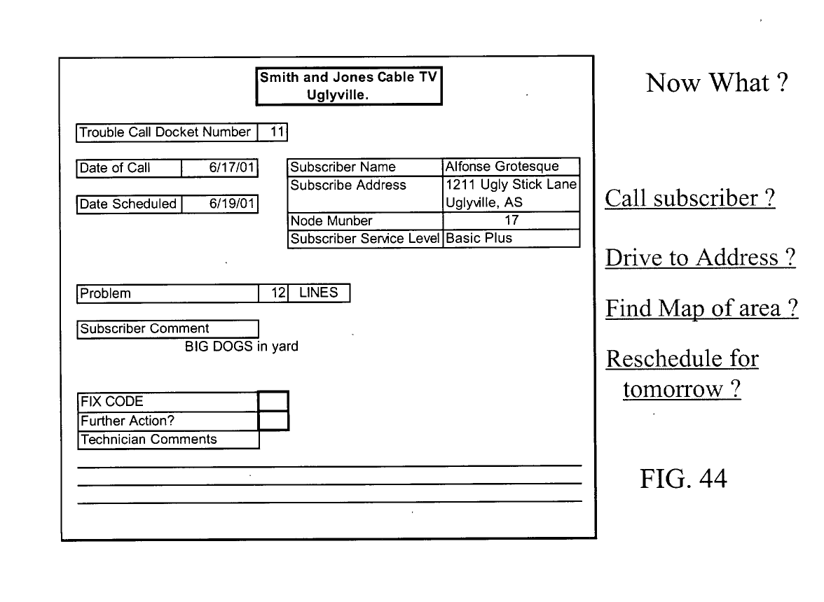

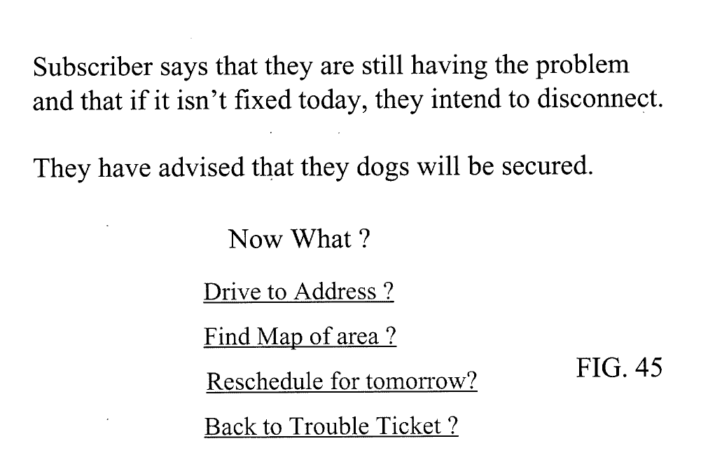

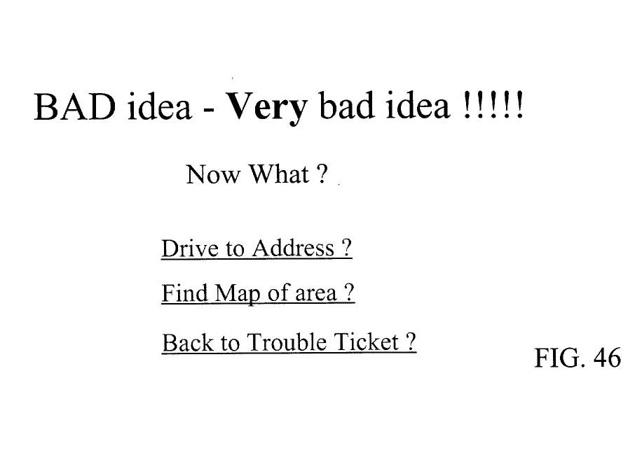

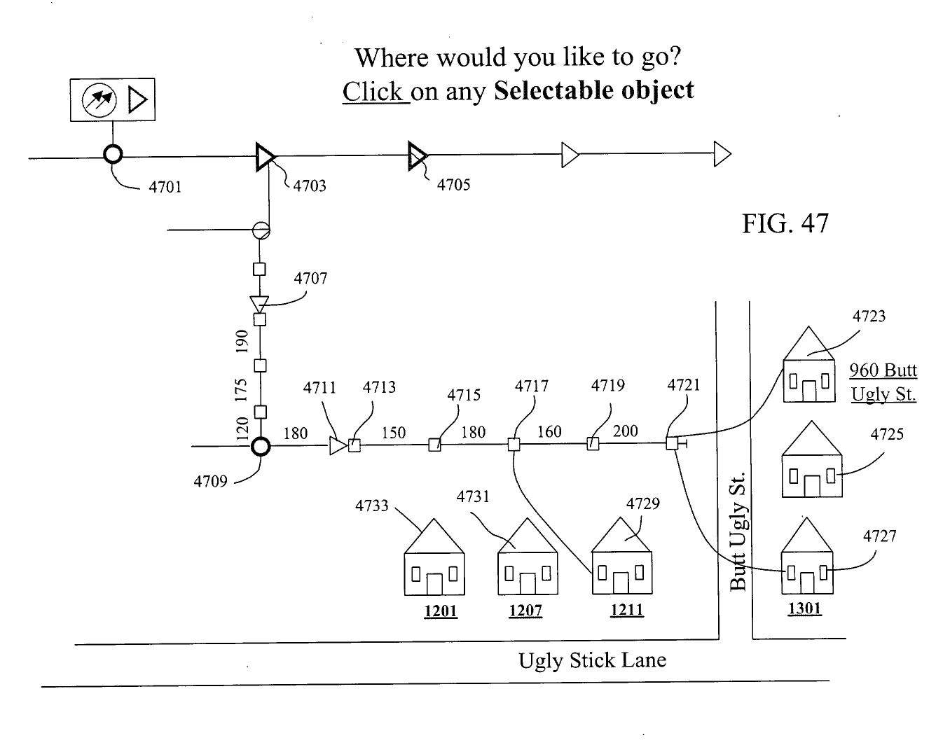

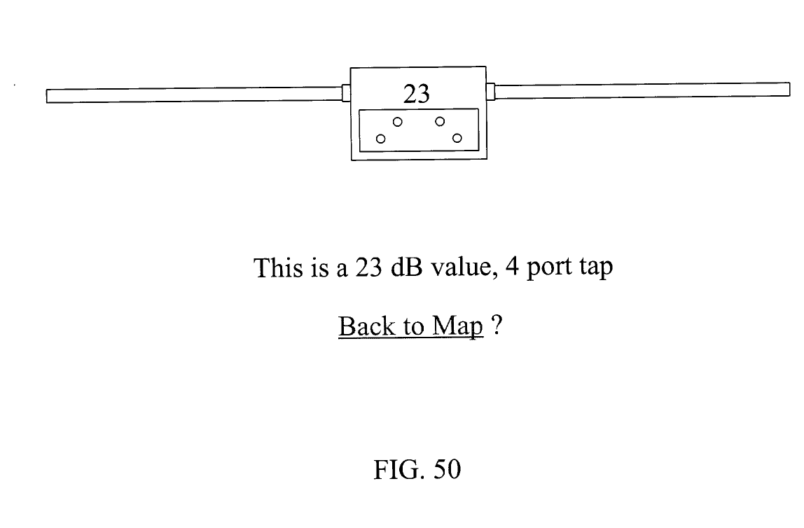

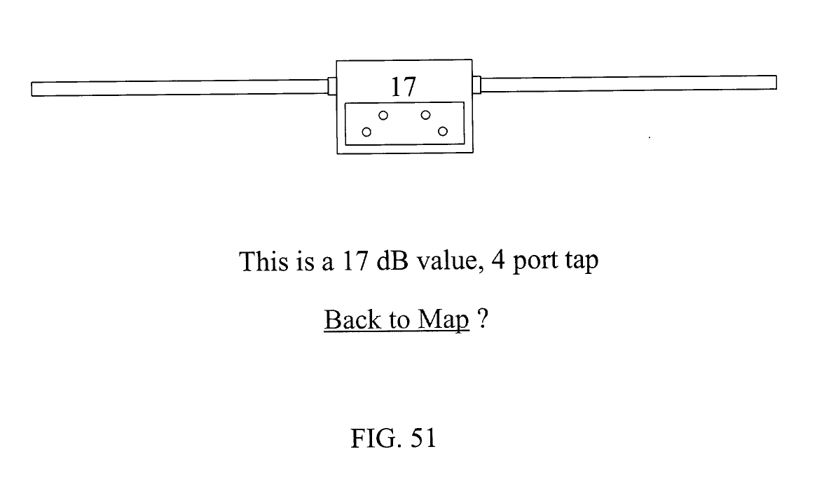

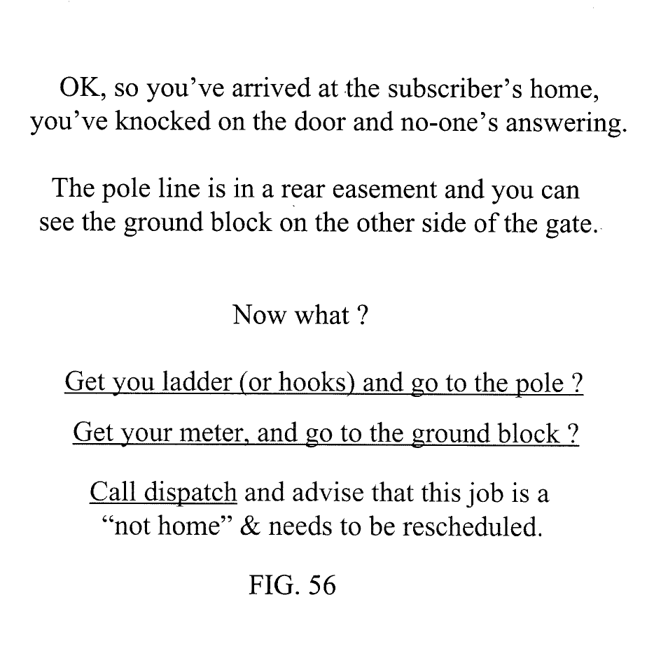

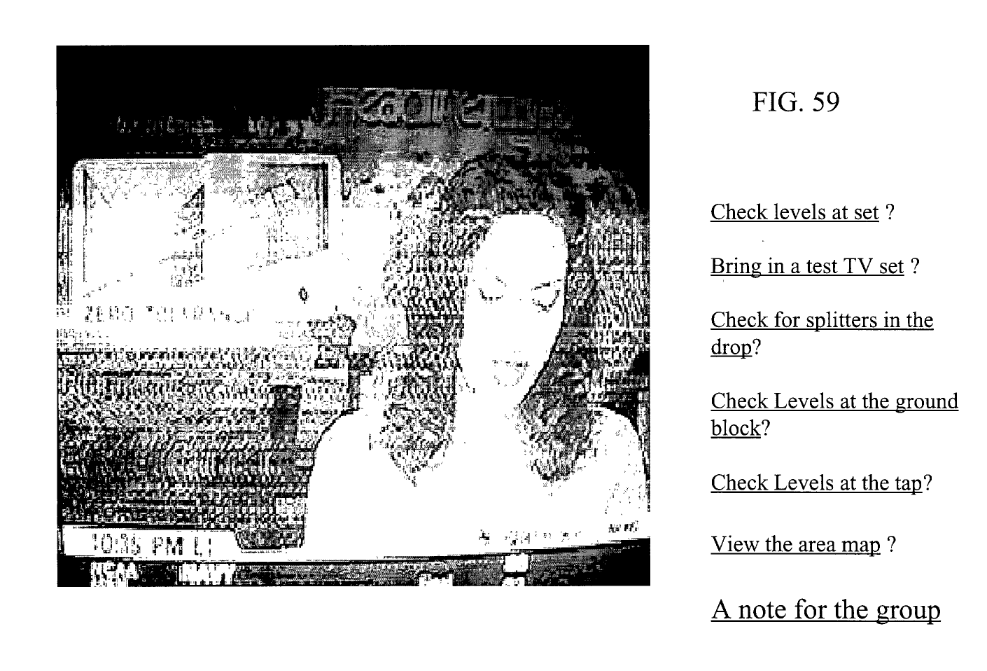

FIGS. 44-85 are exemplary screen shots illustrating an exemplary trouble ticket and selectable options in a virtual tech trainer session. FIG. 44 is a screen shot of the initial trouble ticket indicating the problem “LINES” and incorporating other information, such as date of call, date scheduled for service and subscriber information (name, location, subscriber service level, subscriber comments, etc.). The trouble ticket further includes several selectable options for the user to determine the next course of action. Selection of a “Call Subscriber” graphic causes display of a subscriber discussion screen shot shown on FIG. 45. Selection of a “Drive to Address” graphic causes display of a subscriber location screen shot shown on FIG. 56. Selection of a “Find Map of area?” graphic causes display of an area network map screen shot shown on FIG. 47. Selection of a “Reschedule for tomorrow” graphic causes display of a “Bad Idea” screen shot shown on FIG. 46, indicating that this is not an acceptable choice. The subscriber discussion screen shot shown on FIG. 45 includes a telephonic discussion report with the subscriber and several selectable options. Selection of a “Drive to Address” graphic causes display of a subscriber television display screen shot shown on FIG. 59. In this case, it may be assumed that the subscriber is home since the discussion with the subscriber implies a mutually-agreed upon time. Selection of a “Find Map of area?” graphic causes display of the area network map screen shot of FIG. 47. Selection of a “Reschedule for tomorrow” graphic causes display of the Bad Idea screen shot of FIG. 46. Selection of a “Back to Trouble Ticket?” graphic returns the user to the trouble ticket screen shot of FIG. 44. The Bad Idea screen shot of FIG. 46 includes several options in the event the user chose poorly and ended up here. Selection of a “Drive to Address” graphic causes the system to jump to the television display screen shot of FIG. 59, if the subscriber is deemed home, or to the subscriber location screen shot of FIG. 56. Selection of a “Find Map of area?” graphic causes display of the network map screen shot of FIG. 47. Selection of a “Back to Trouble Ticket?” graphic returns the user to the trouble ticket screen shot of FIG. 44.

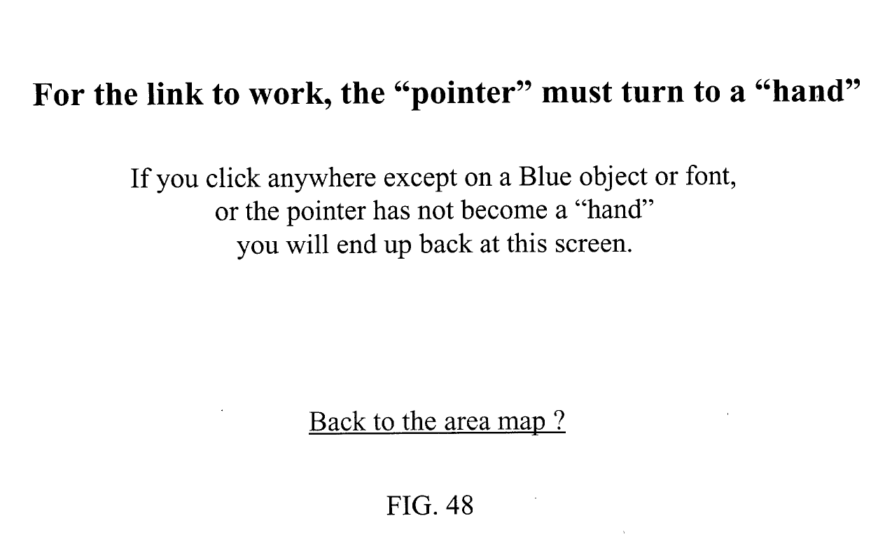

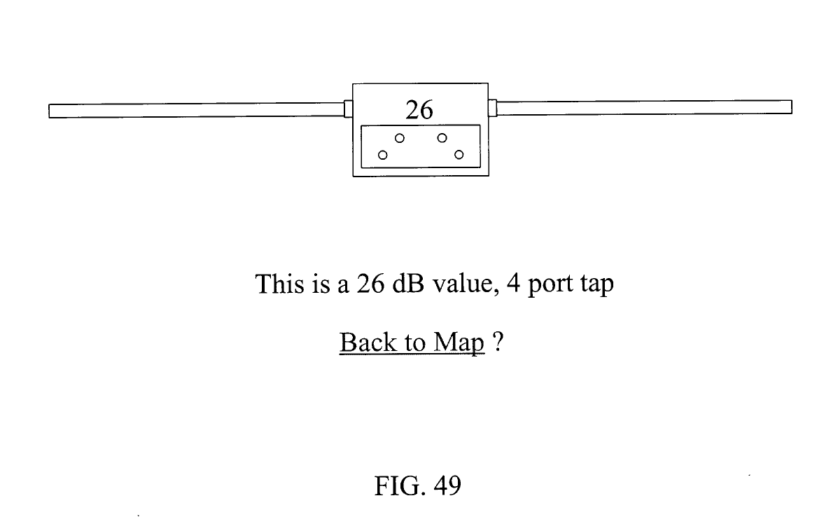

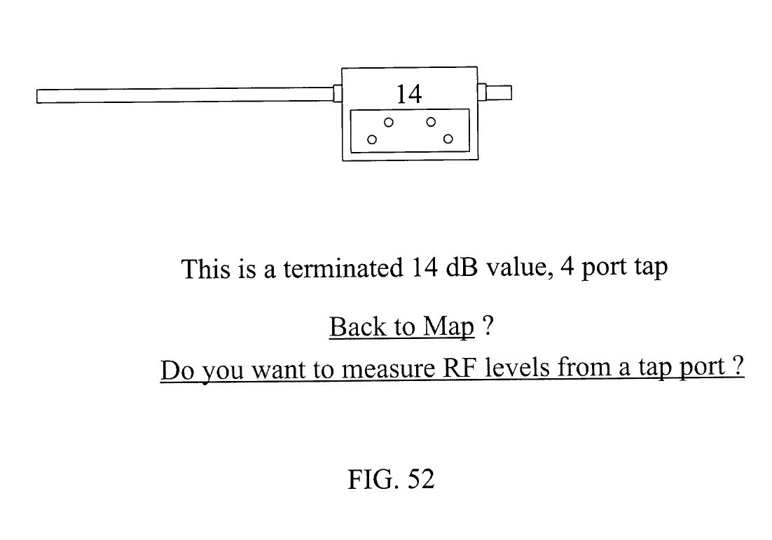

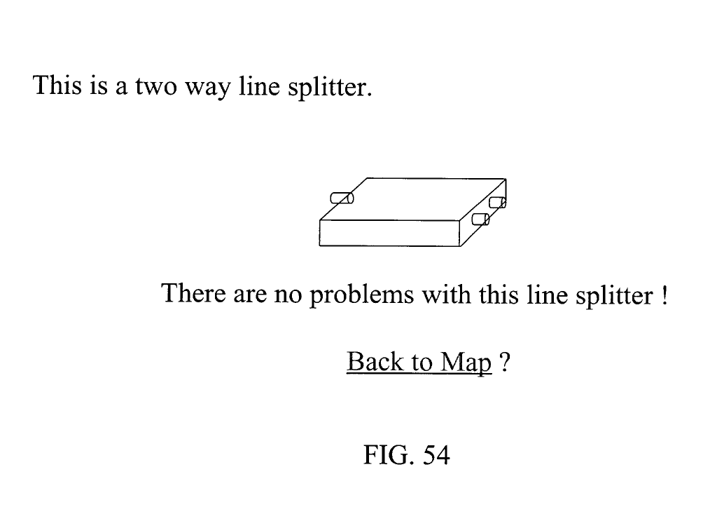

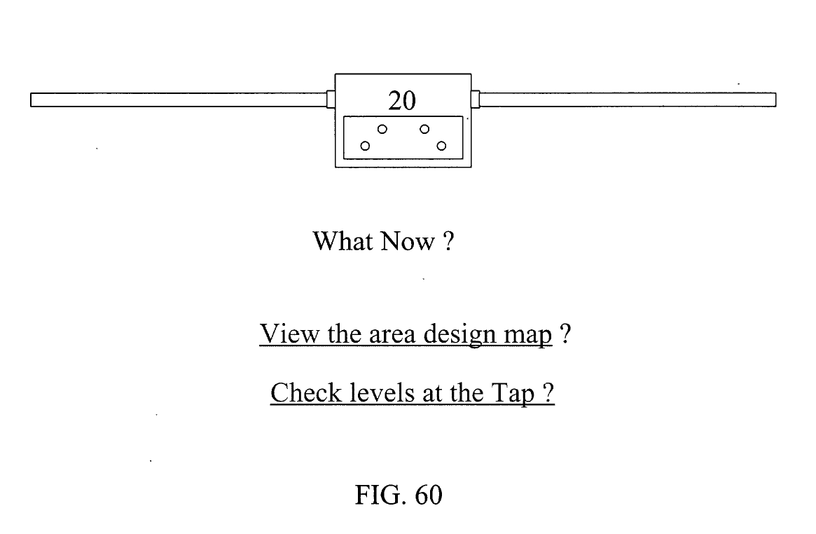

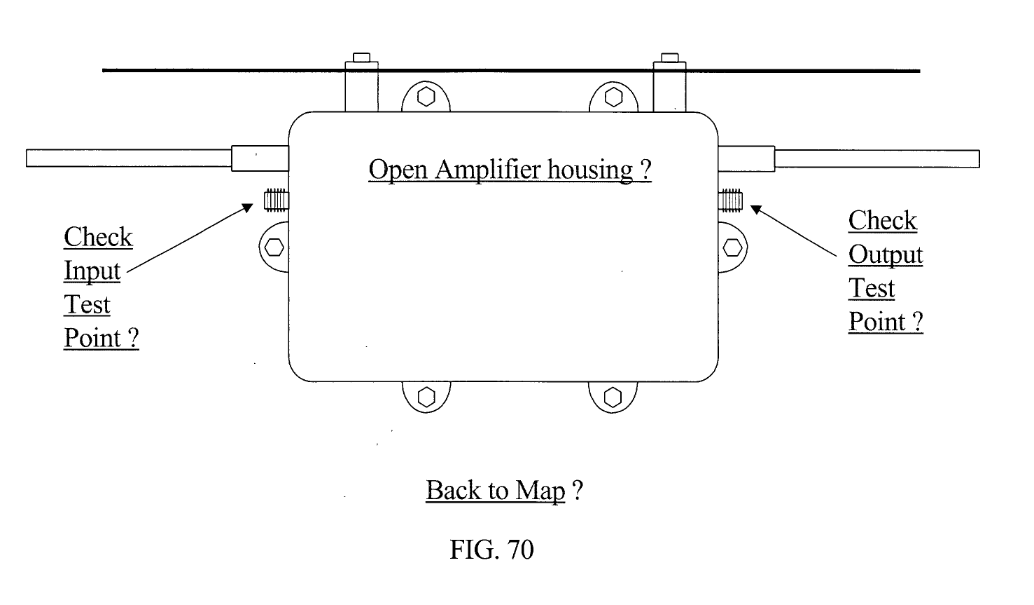

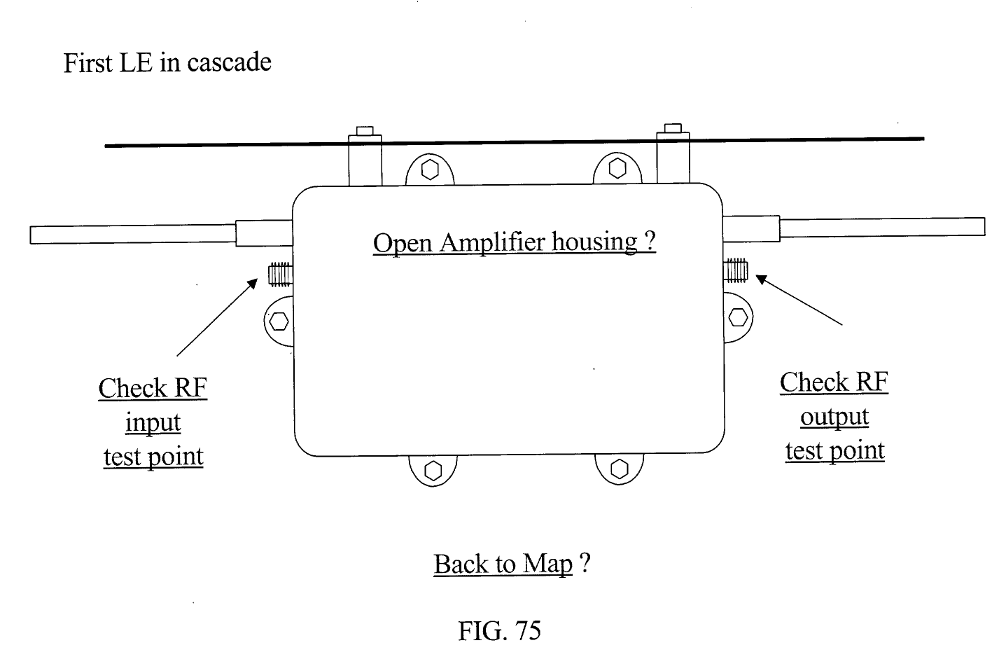

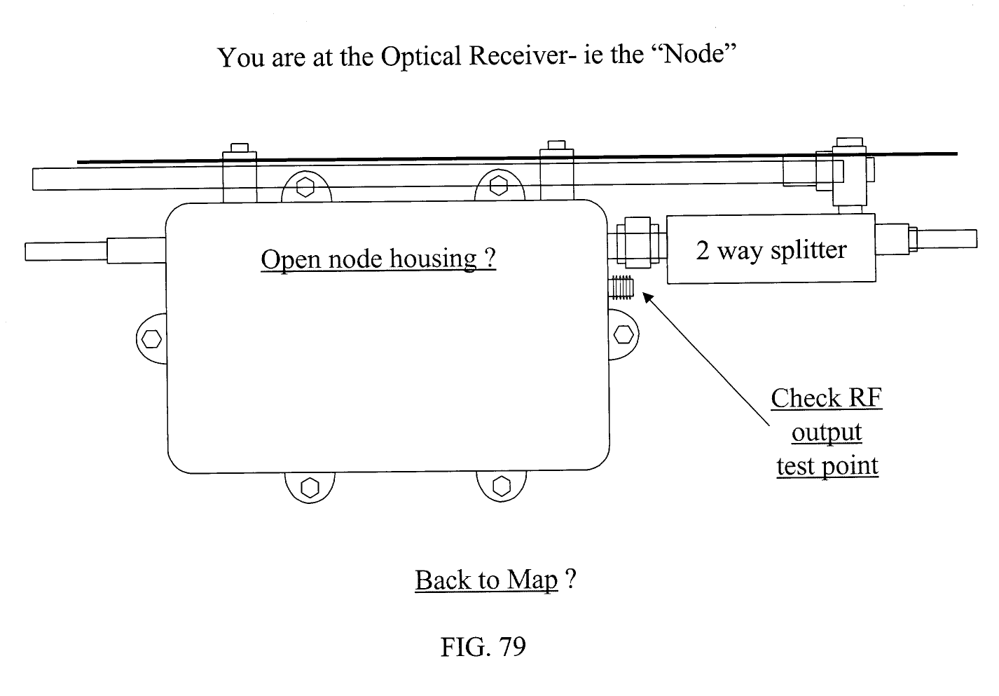

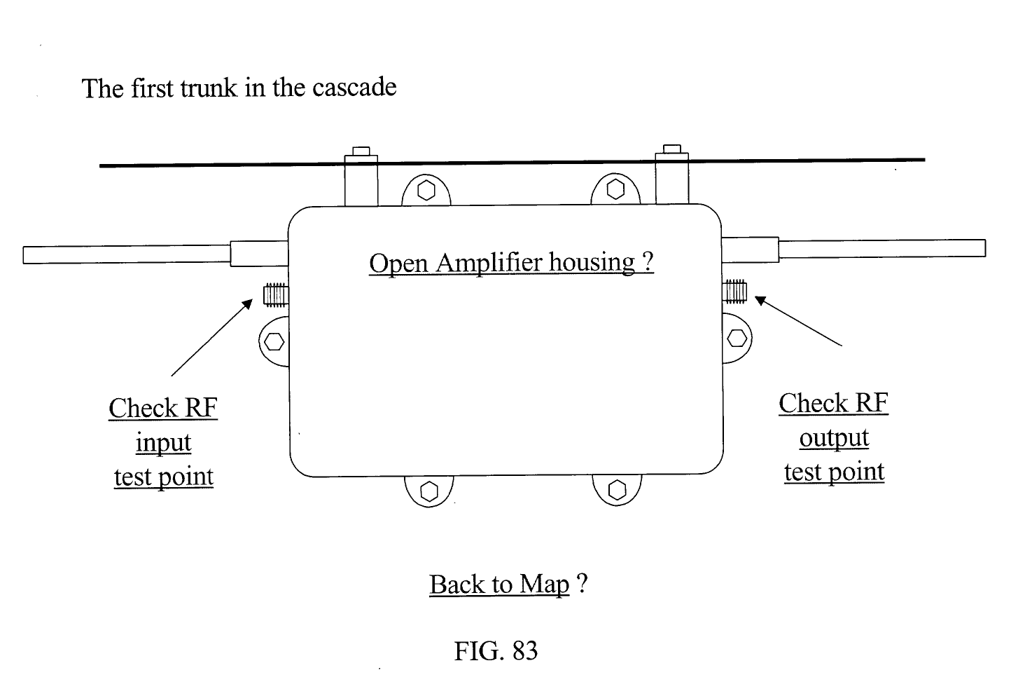

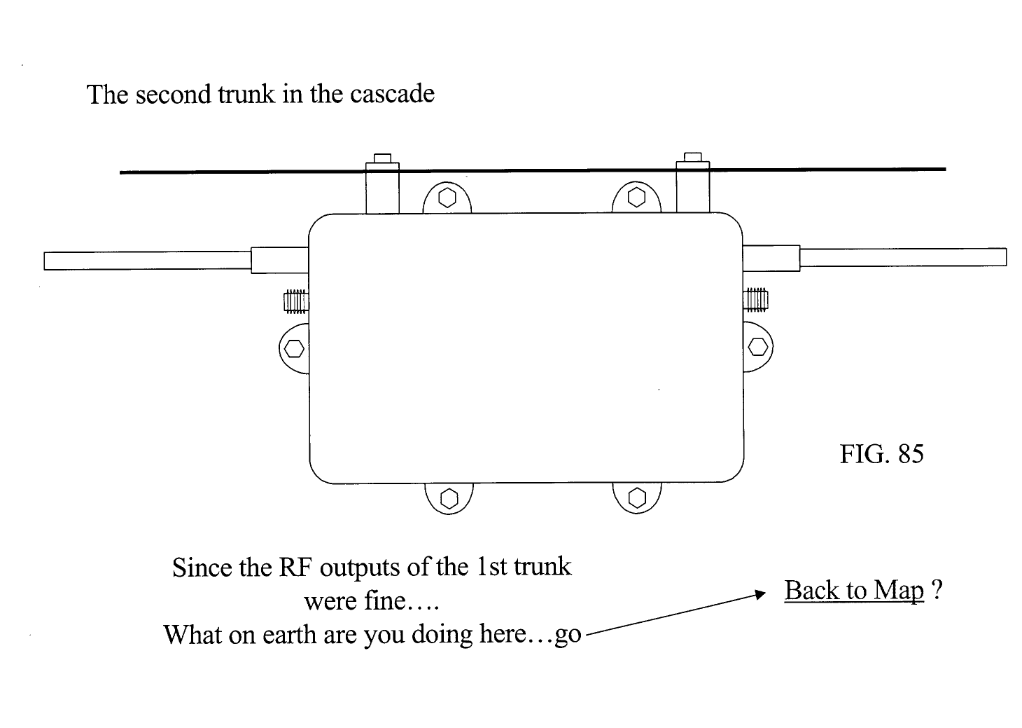

FIG. 47 is the area map screen shot including several selectable items, including multiple components in the network, subscriber locations and non-subscriber locations that are highlighted on some manner to indicate a selectable object, such as by color, by indication of hypertext, by change of cursor (hand or the like similar to browser), etc. Failure to click or select an appropriate object causes display of a pointer failure screen shown in FIG. 48, which includes a link back to the area map screen shot of FIG. 47. Selection of an optical graphic object 4701 causes display of an optical receiver screen shot shown in FIG. 79. Selection of an amplifier graphic object 4703 causes display of the first trunk in the cascade screen shot shown in FIG. 83. Selection of an amplifier graphic object 4705 causes display of a second trunk in the cascade screen shot shown in FIG. 85. Selection of an amplifier graphic object 4707 causes display of a first line extender (LE) in the cascade screen shot shown in FIG. 75. Selection of a splitter graphic object (circular) 4709 causes display of a splitter screen shot shown in FIG. 54, with a link back to the area map of FIG. 47. Selection of an amplifier graphic object 4711 causes display of an amplifier screen shot shown in FIG. 70. Selection of any of the tap graphic objects (square) 4713, 4715 or 4719 causes display of corresponding tap screen shots shown in FIGS. 49, 50 or 51, respectively, each simply showing a tap with corresponding dB value and a link back to the map. Selection of a tap graphic object 4717 causes display of a tap screen shot for the subscriber that called in the trouble ticket shown in FIG. 60. Selection of a tap graphic object 4721 causes display of a tap screen shot for other subscribers shown in FIG. 52.

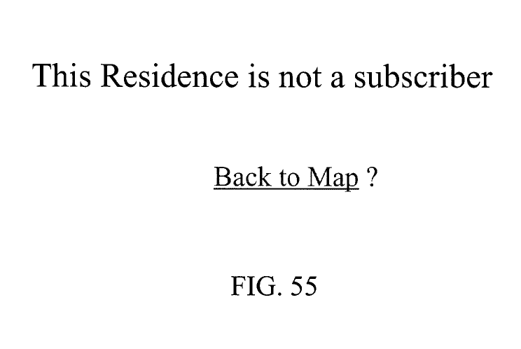

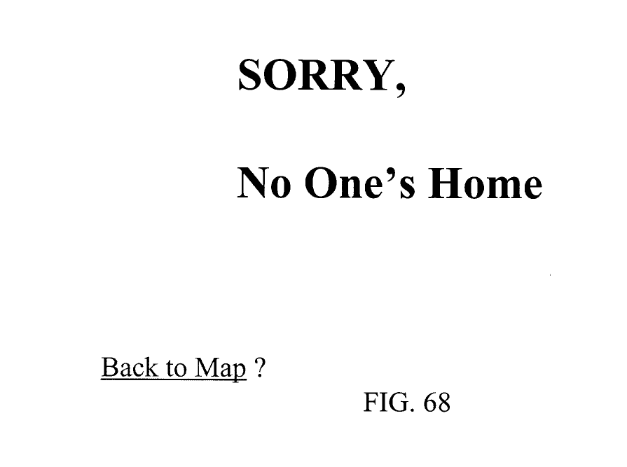

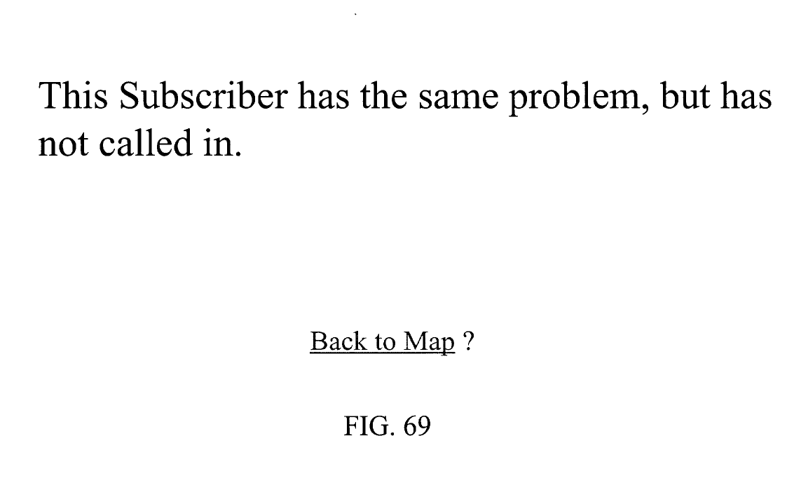

The area network map screen of FIG. 47 also includes various house graphics of subscribers and non-subscribers. Selection of any of the non-subscriber house icons 4725, 4731 or 4733 causes display of a non-subscriber screen shown in FIG. 55, with a link back to the map. Selection of the subscriber icon 4723 causes display of an additional subscriber information screen shot shown in FIG. 69, with a link back to the map. Selection of the subscriber icon 4727 causes display of a subscriber not home screen shot shown in FIG. 68, with a link back to the map. Selection of the subscriber icon 4729 causes display of the subscriber television display screen of FIG. 59 (if subscriber is home).

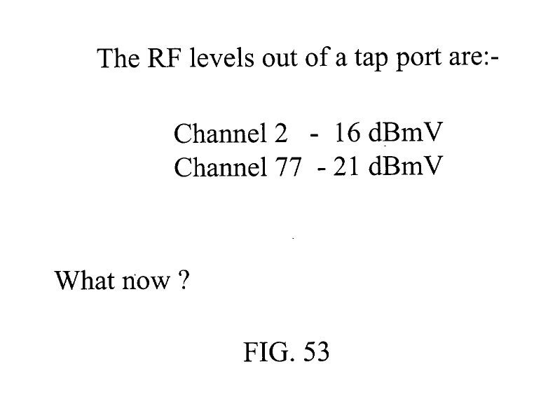

The tap screen shot for other subscribers of FIG. 52 includes a link back to the area map of FIG. 47 and an additional query selectable link if the user wants to measure the RF levels of this tap port. Selection of this link causes display of an RF measurement screen shot shown in FIG. 53, and any click brings the user back to the area map of FIG. 47.

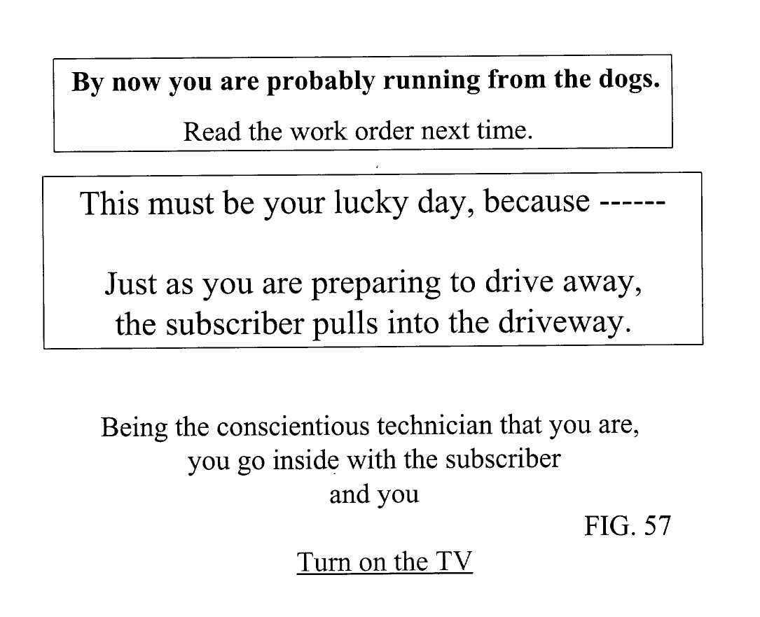

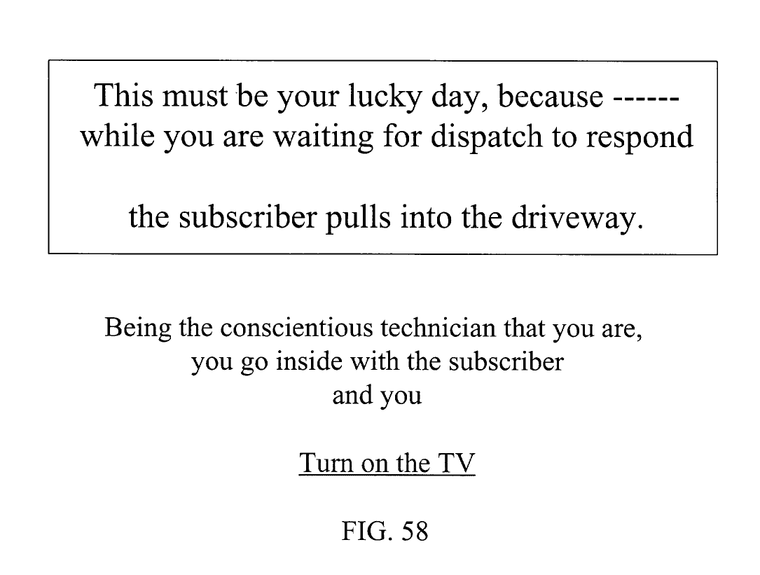

The subscriber location screen shot of FIG. 56 includes one or more selectable actions items. Two selectable items, “getting a ladder and go to pole” or “getting meter and going to ground block” would result in entry of the subscriber's premises while not home, causing display of a result screen shot shown in FIG. 57. In either case, it is indicated that the user is running from dogs, since the user ignored the subscriber comment on the trouble ticket indicating the presence of large dogs. In this particular case, the subscriber shows up while the user is leaving, so that the user is able to link to the subscriber television display screen of FIG. 59. Another “Call dispatch” selectable graphic causes display of a different result screen shown in FIG. 58 in which the user meets the subscriber just in time without having been chased by large dogs. Again, the user is able to link to the subscriber television display screen of FIG. 59.

FIG. 59 is an exemplary subscriber television display screen shot illustrating the “lines” problem that caused the subscriber to call. A plurality of various television screen clips are provided to reflect actual television responses indicative of corresponding network problems. The user has several options to choose from in order to diagnose and solve the problem. An extra “A note for the group.” graphic links to an information note page (not shown) that explains that a well trained technician would recognize the problem based on the characteristic lines displayed on the subscriber's television. At least one goal of the tech trainer, however, is to ask the user what they want to do and evaluate the selected actions with feedback, if desired, such as a score, or suggestions, etc.

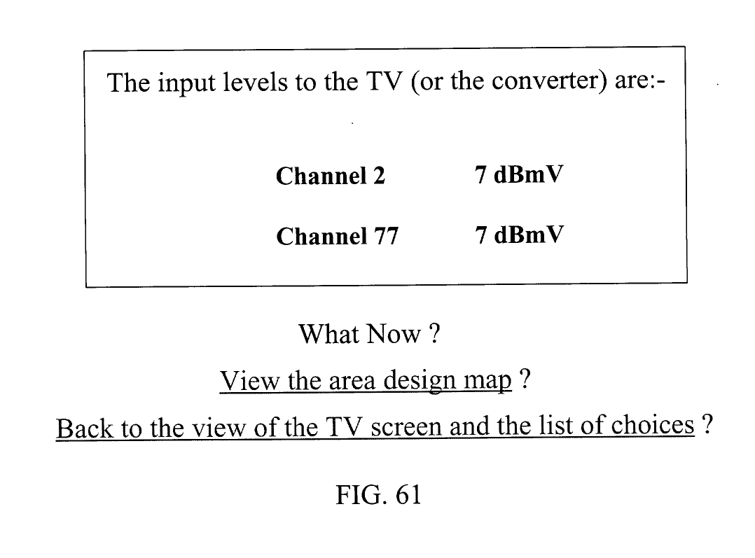

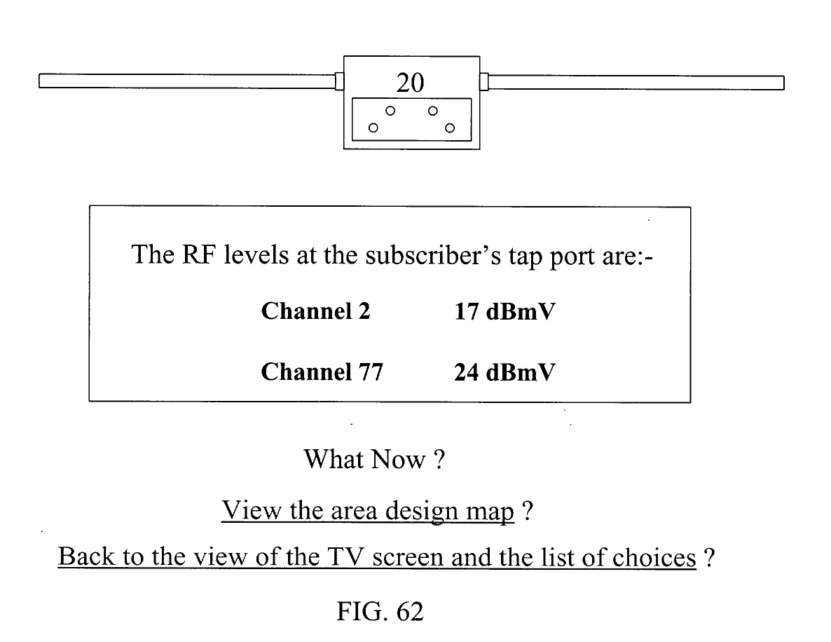

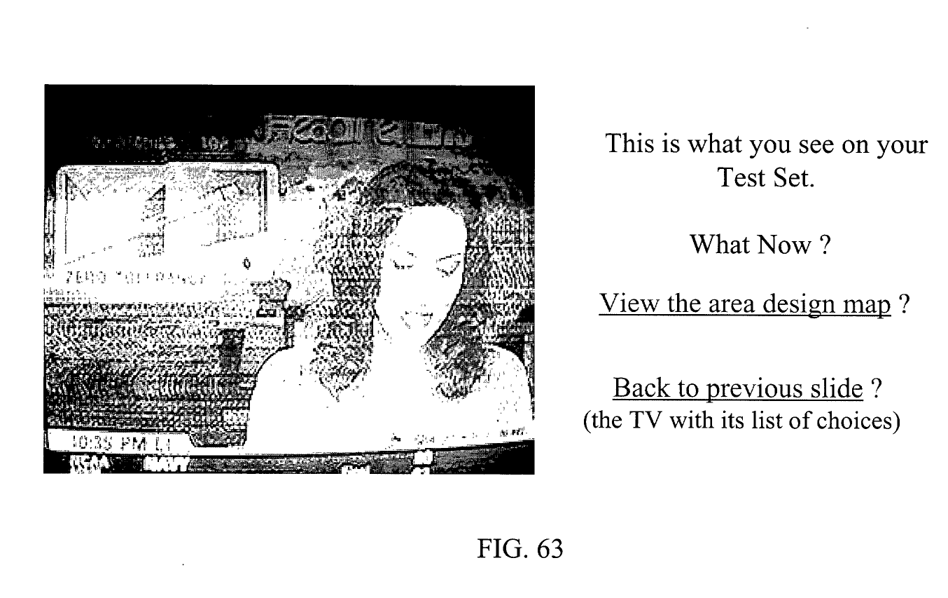

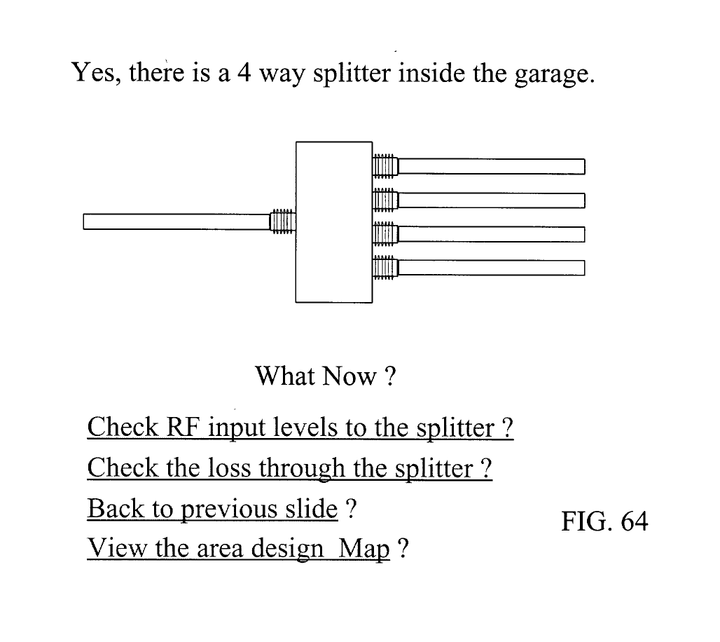

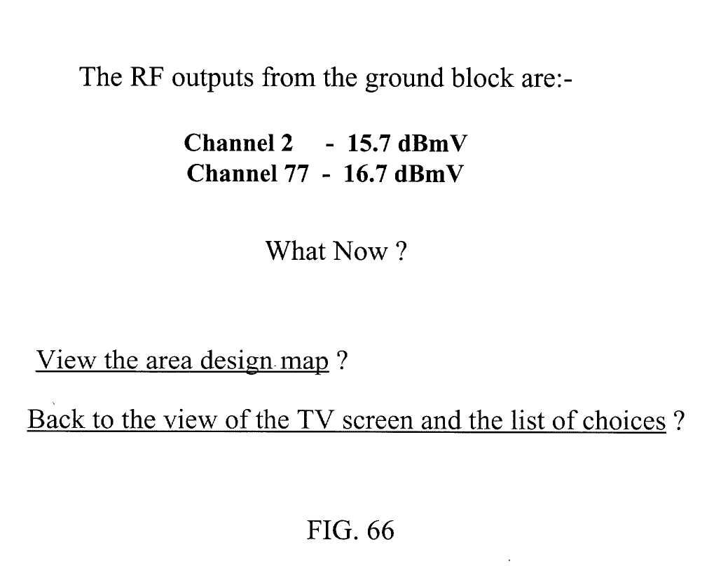

At FIG. 59, a selection of a “Check levels at set?” link causes display of a TV input level screen shot shown in FIG. 61. Selection of a “Bring in a test TV set?” link causes display of a test TV set screen shot shown in FIG. 63. Selection of a “Check for splitters in the drop?” link causes display of a 4-way splitter screen shot shown in FIG. 64. Selection of a “Check Levels at the ground block?” link causes display of an RF outputs of the ground block screen shot shown in FIG. 66. Selection of a “Check Levels at the tap?” link causes display of an RF levels at the subscriber's tap port screen shot shown in FIG. 62. Selection of a “View the area map?” link causes display of the area map of FIG. 47.

FIG. 60 is a tap screen shot for the subscriber indicating dB level and including further selections. Selection of a “View the area design map?” link causes return to the area map of FIG. 47. Selection of a “Check levels at the Tap?” link causes display of the RF levels at the subscriber's tap port screen shot of FIG. 62. FIG. 61 is the TV input level screen shot including channel readings (for channels 2 and 77) and two links including a first link back to the area map of FIG. 47 and a second link back to the subscriber television display screen shot of FIG. 59. FIG. 62 is the RF levels at the subscriber's tap port screen shot indicating dB level and channel readings for channels 2 and 77, along with further selections, including a first link back to the area map of FIG. 47 and a second link back to the subscriber television display screen shot of FIG. 59. FIG. 63 is the test TV set screen shot including a first link back to the area map of FIG. 47 and a second link back to the subscriber television display screen shot of FIG. 59. In this example, the test set shows the same picture as the subscriber's TV set indicating that the problem is not the subscriber's television.

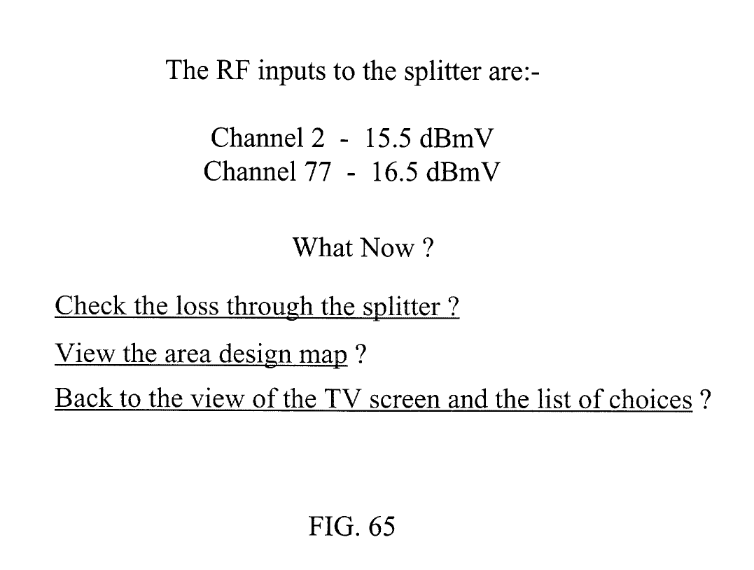

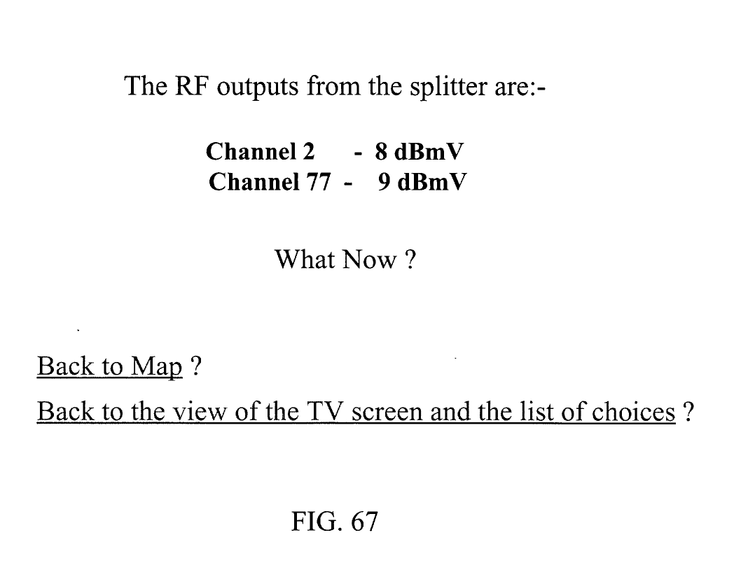

FIG. 64 is the 4-way splitter screen shot of a splitter located in the subscriber's garage. Selection of a “Check RF input levels to the splitter?” link causes display of an RF inputs to the splitter screen shot shown in FIG. 65. Selection of a “Check the loss through the splitter?” link causes display of an RF outputs from the splitter screen shot shown in FIG. 67. Two additional links are provided in FIG. 64 including a first link back to the area map of FIG. 47 and a second link back to the subscriber television display screen shot of FIG. 59. FIG. 65 is the RF inputs to the splitter screen shot showing input levels at the selected channels 2 and 77. Selection of a “Check the loss through the splitter?” link causes display of the RF outputs from the splitter screen shot of FIG. 67. Two additional links are provided in FIG. 65 including a first link back to the area map of FIG. 47 and a second link back to the subscriber television display screen shot of FIG. 59. FIG. 66 is the RF outputs from the ground block shot showing output levels at the selected channels 2 and 77 with the links back to the area map of FIG. 47 and the subscriber television display screen shot of FIG. 59. FIG. 67 is the RF outputs from the splitter shot showing output levels at the selected channels 2 and 77 with the links back to the area map of FIG. 47 and the subscriber television display screen shot of FIG. 59.

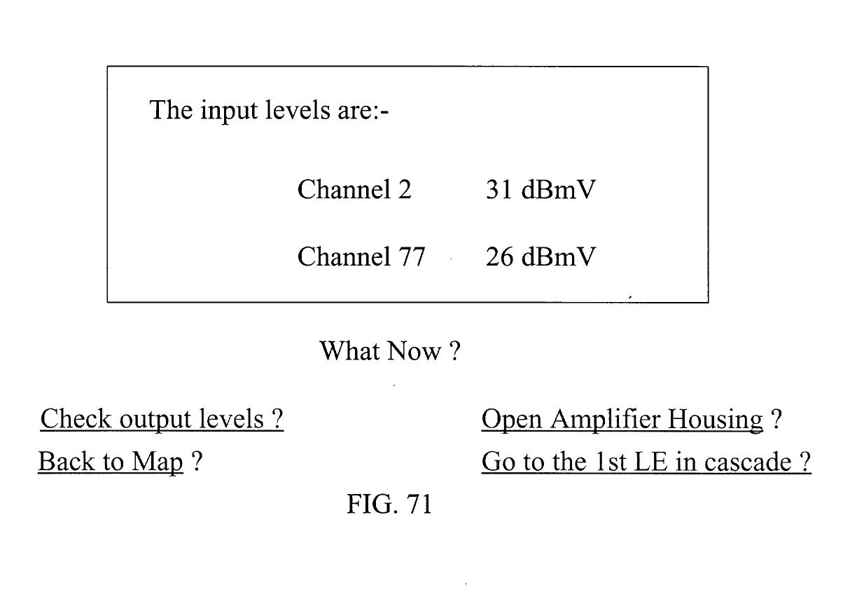

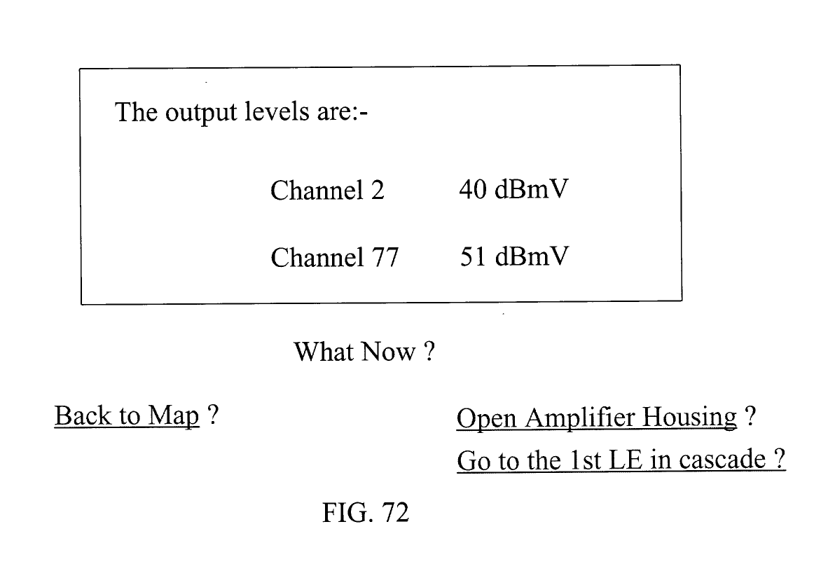

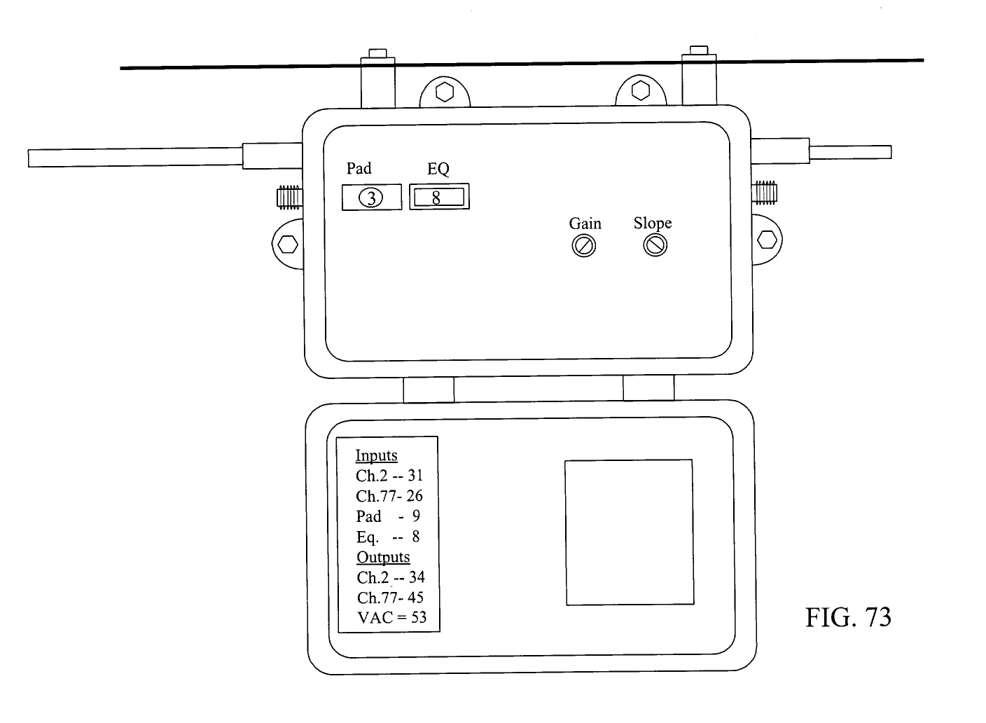

FIG. 70 amplifier screen shot including an amplifier graphic and several selectable links. Selection of a “Check Input Test Point?” link causes display of an input levels screen shot shown in FIG. 71. Selection of a “Check Output Test Point?” link causes display of an output levels screen shot shown in FIG. 72. Selection of an “Open Amplifier housing?” link causes display of a screen shot with graphics illustrating internal portions of the amplifier as shown in FIG. 73. A link is provided to return the user back to the area map of FIG. 47.

FIG. 71 is the input levels screen shot for an amplifier including measurements of the input levels of the selected channels and additional selectable links. Selection of a “Check output levels?” link causes display of the output levels screen shot of FIG. 72. Selection of an “Open Amplifier Housing?” link causes display of the screen shot of FIG. 73 with graphics illustrating internal portions of the amplifier. Selection of a “Go to the 1^{st} LE in cascade?” link causes display of the First LE in cascade screen shot of FIG. 75. The screen shot of FIG. 71 also includes a return link to the area map of FIG. 47.

FIG. 72 is the output levels screen shot of an amplifier including similar options as FIG. 71. Selection of an “Open Amplifier Housing?” link causes display of the screen shot of FIG. 73 with graphics illustrating internal portions of the amplifier. Selection of a “Go to the 1^{st} LE in cascade?” link causes display of the First LE in cascade screen shot of FIG. 75. The screen shot of FIG. 72 also includes a return link to the area map of FIG. 47.

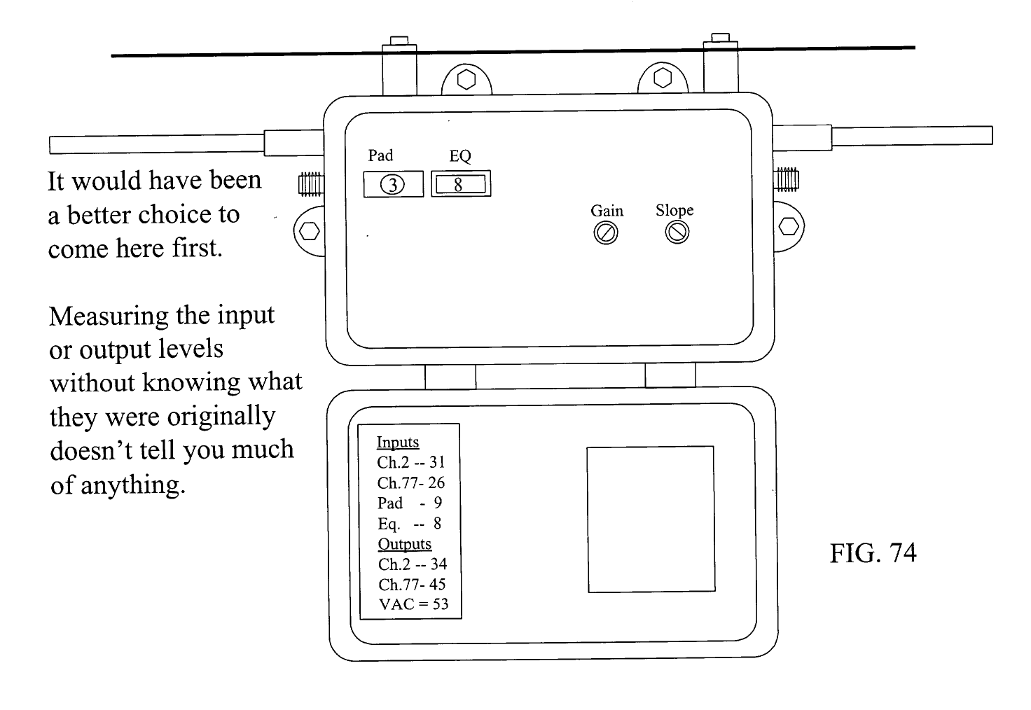

FIG. 73 is the screen shot with graphics illustrating internal portions of the amplifier, which links to a similar graphic shown in FIG. 74. In fact, FIG. 74 is essentially identical except including a note that the user should have come to this location first rather than measuring the input and output levels without knowing their original values.

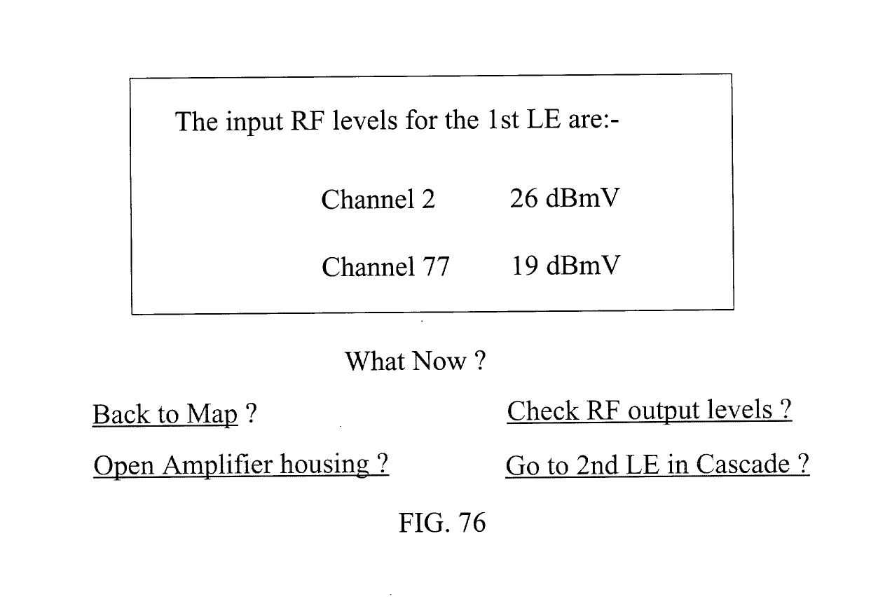

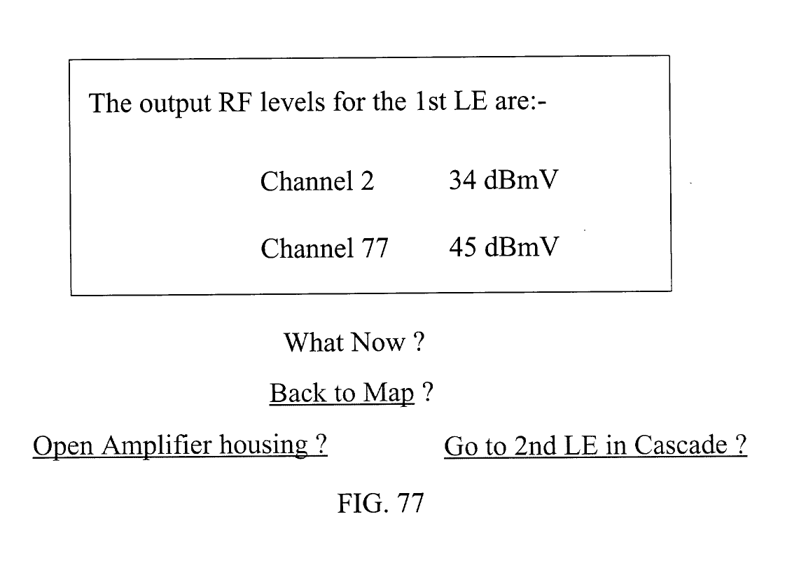

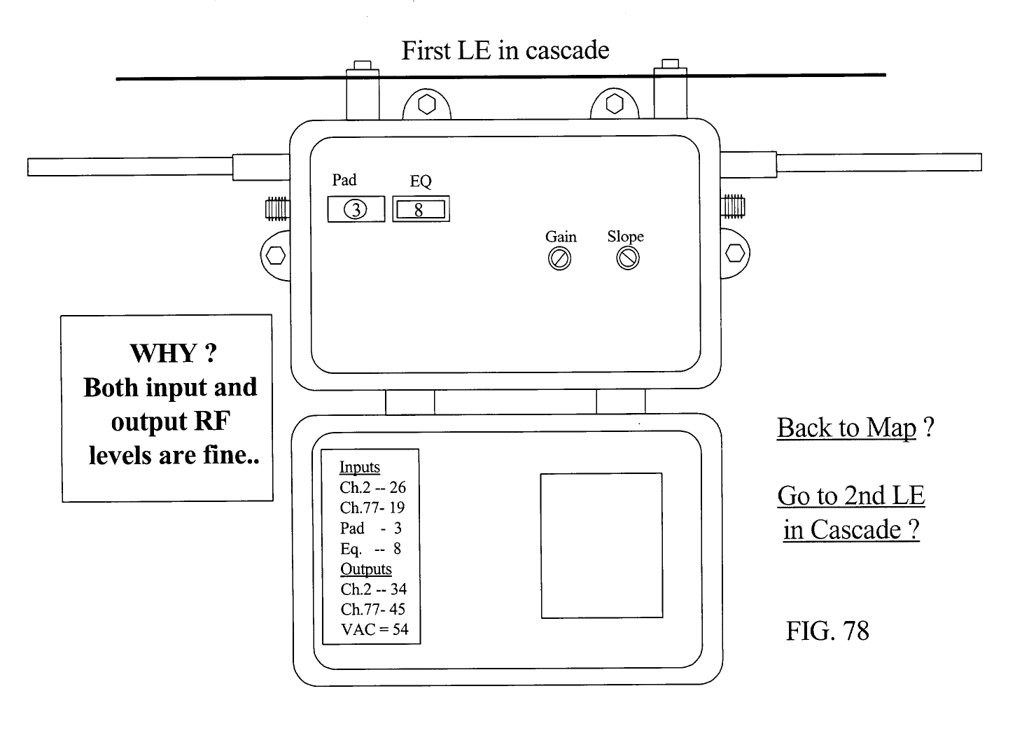

FIG. 75 is the First LE in cascade screen shot. Selection of a “Check RF input test point?” link causes display of an input RF levels screen shot for the 1^{st} LE shown in FIG. 76. Selection of a “Check RF output test point?” link causes display of an output RF levels screen shot for the 1^{st} LE shown in FIG. 77. Selection of an “Open Amplifier housing?” link causes display of a screen shot with graphics illustrating internal portions of the First LE in cascade as shown in FIG. 78. A link is provided to return the user back to the area map of FIG. 47.

FIG. 76 is the input RF levels screen shot for the 1^{st} LE including measurements of the input levels of the selected channels 2 and 77 and additional selectable links. Selection of a “Check RF output levels?” link causes display of the output RF levels screen shot for the 1^{st} LE of FIG. 77. Selection of an “Open Amplifier housing?” link causes display of the screen shot of FIG. 78 with graphics illustrating internal portions of the First LE in cascade. Selection of a “Go to the 2^{nd} LE in cascade?” link causes display of the amplifier screen shot of FIG. 70. The screen shot of FIG. 76 also includes a return link to the area map of FIG. 47.

FIG. 77 is the output RF levels screen shot for the 1^{st} LE screen shot including similar options as FIG. 76. Selection of an “Open Amplifier housing?” link causes display of the screen shot of FIG. 78. Selection of a “Go to the 2^{nd} LE in cascade?” link causes display of the amplifier screen shot of FIG. 70. The screen shot of FIG. 77 also includes a return link to the area map of FIG. 47.

FIG. 78 is the screen shot with graphics illustrating internal portions of the First LE in cascade. This page includes a note querying why the user came to this point since both the input and output RF levels were within specification. Therefore, this step causes a reduced score and cost in terms of time and efficiency. The user should quickly learn after one or more iterations to avoid these mistakes. FIG. 78 includes a link back to the area map of FIG. 47 and a similar “Go to the 2^{nd} LE in cascade?” link causing display of the amplifier screen shot of FIG. 70.

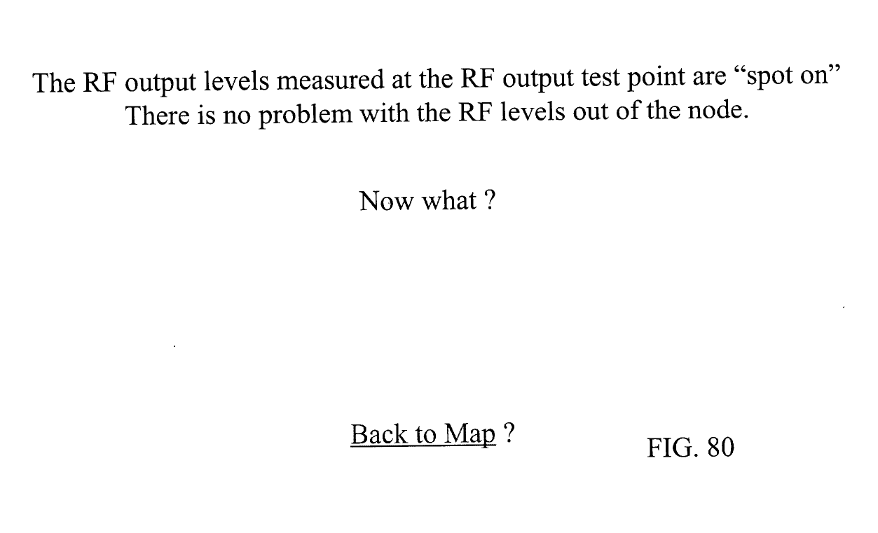

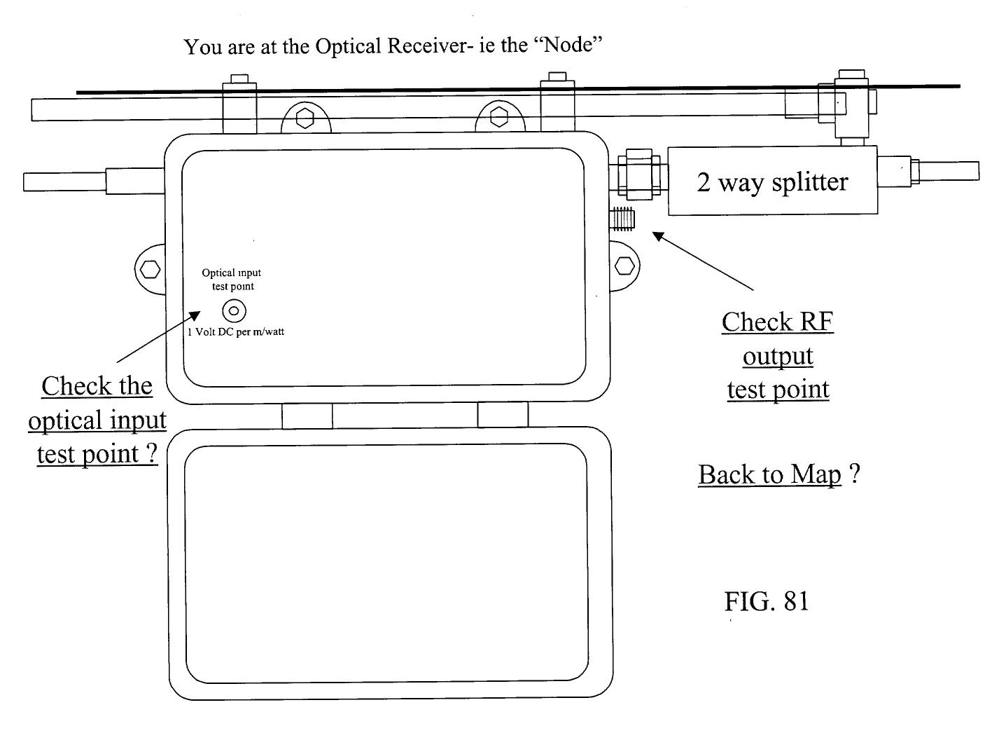

FIG. 79 is the optical receiver node screen shot. Selection of an “Open node housing?” link causes display of a screen shot of FIG. 81 with graphics illustrating internal portions of the optical node. Selection of a “Check RF output test point?” link causes display of the output RF levels measured at the RF output test point screen shot for the node shown in FIG. 80. The screen shot of FIG. 79 also includes a return link to the area map of FIG. 47.

FIG. 80 is the output RF levels measured at the RF output test point screen shot for the optical receiver node. This page indicates that the RF output levels are within specification and that there is no problem with the RF levels. A link is provided back to the area map of FIG. 47.

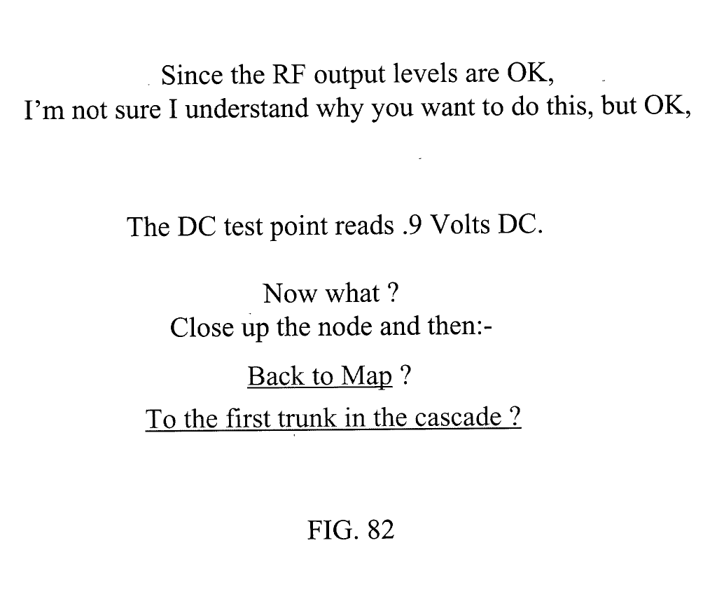

FIG. 81 is the screen shot with graphics illustrating internal portions of the optical node. Selection of a “Check the optical input test point?” link causes display of an RF output levels screen shot for the optical node as shown in FIG. 82. Selection of a “Check RF output test point?” link causes display of the output RF levels measured at the RF output test point screen shot for the node of FIG. 80. A link is provided back to the area map of FIG. 47.

FIG. 82 is the RF output levels screen shot for the optical node indicating that the RF output levels are within specification. Further, the page indicates that this step is unnecessary, but provides the results of the tests. A link is provided back to the area map of FIG. 47. Selection of a “To the first Trunk in the cascade?” link causes display of the first trunk in the cascade screen shot of FIG. 83.

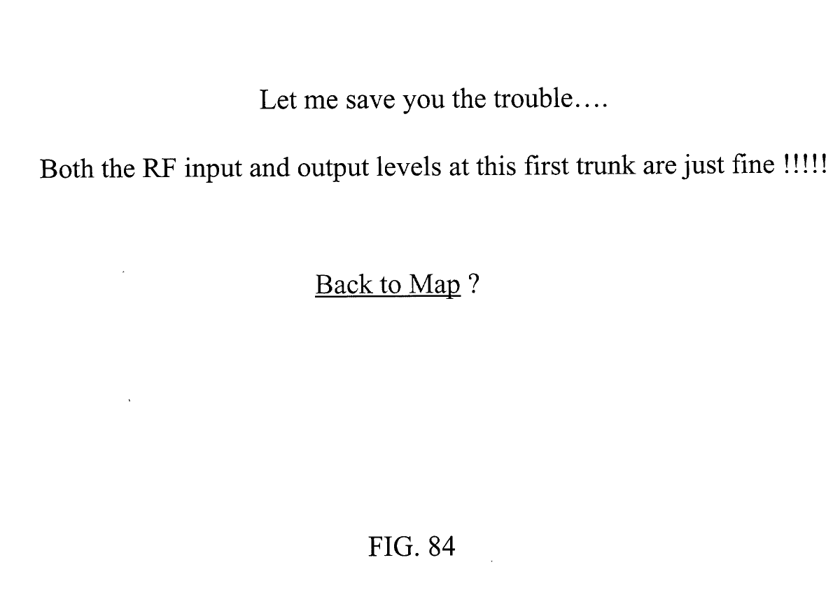

FIG. 83 is the first trunk in the cascade screen shot including a graphic of the amplifier and several selectable options. Selection of either a “Check RF input test point?” link or a “Check RF output test point?” link causes display of results page shown in FIG. 84. In either case, the RF levels are fine indicating that this may be an unnecessary step. FIG. 84 includes a link back to the area map of FIG. 47. Selection of an “Open Amplifier housing?” link causes display of the screen shot with graphics illustrating internal portions of the First LE in cascade as shown in FIG. 78. A link is provided to return the user back to the area map of FIG. 47.

FIG. 85 is the second trunk in the cascade screen shot. In this case, it is noted that since the RF outputs of the 1^{st} trunk were within specification, this step is unnecessary. A return link is provided to the area map of FIG. 47.

It is noted that there are at least 11 different problems that result in a symptom defined as “Lines”, including second order distortions, co-channel interference, cross modulation, excessive 60 Hz hum, ingress, FM, ham &/or off-air TV direct pick up, VCR problems, badly aligned TVRO dishes, insufficient isolation between modulators, terrestrial interference and private “in-house” amplifiers, among others. In the exemplary case illustrated above, there was only one call, and the design map indicates that the subscriber is served by distribution from the first trunk amplifier in the cascade. If the problem was trunk or node related, it would be reasonable to initially assume that there would be many more calls. One look at the subscriber's TV screen should have indicated that the problem was distortion related. Unless there was an “in house” drop amplifier, there was nothing between the set and the last active (the LE) that could cause these distortions. The problem could have been either the first or second line extender (LE). Due, again, to the lack of trouble calls, checking the second LE would be reasonable. A review of either the “as built” notes inside the housing or the tombstone on the design maps would quickly indicate that the output of the 2nd LE was way too high. Opening the housing reveals that someone has replaced the 9 dB pad with a 3 dB pad, causing the output to rise 6 dB, thus the distortions as seen on the TV set.

It is appreciated that the examples and Figures described herein are simplified for clarity of explanation and that each tech assistant embodiment incorporates many complexities that would be too exhaustive to illustrate herein. For example, many configurations would include multiple trouble tickets randomly selected along with randomly selected or selectable conditions and situations so that it is conceivable that very few, if any, user sessions would be the same. Nonetheless, the examples provided herein demonstrate the basic principles that are applied to each embodiment of the invention.

Although a system and method according to the present invention has been described in connection with one or more embodiments of the invention, it is not intended to be limited to the specific form set forth herein, but on the contrary, it is intended to cover such alternatives, modifications, and equivalents, as can be reasonably included within the spirit and scope of the invention as defined by the appended claims.

1. A computer-based field technician trainer, comprising:
a computer with input and output devices including a display; and
software executed on the computer that presents an interactive virtual broadband communication network environment including selectable options and actions and that provides results of selected options and actions to simulate real-world trouble-shooting of network problems.

2. The field technician trainer of claim 1, wherein the virtual broadband communication network environment displays a work order describing subscriber complaint and provides communication options including calls to subscribers and dispatch.

3. The field technician trainer of claim 1, wherein the virtual broadband communication network environment presents a selectable network map of a cable plant including selectable network component graphics.

4. The field technician trainer of claim 1, wherein the virtual broadband communication network environment incorporates and displays a virtual representation of a cable plant including a neighborhood with selectable subscriber locations and network components for inspection.

5. The field technician trainer of claim 4, wherein the virtual broadband communication network environment incorporates virtual measurable values associated with selectable network components indicative of network status and operation reflecting a selected network problem.

6. The field technician trainer of claim 5, wherein the software includes an RF module that calculates the measurable values.

7. The field technician trainer of claim 5, wherein the virtual broadband communication network environment presents selectable virtual test equipment that enable a user to determine measurable values of network components to simulate trouble-shooting procedure.

8. The field technician trainer of claim 7, wherein a network problem is selected from a plurality of known problem types.

9. The field technician trainer of claim 8, wherein the software incorporates proper solution and procedure for each known problem type and evaluates trouble-shooting procedure selected by the user.

10. The field technician trainer of claim 9, wherein the software includes a reporting functions module that logs outcome, progress and performance of a user.

11. The field technician trainer of claim 10, wherein the reporting functions module incorporates difficulty level, skill level, costs and user accuracy and assesses a user score with each training session.

12. The field technician trainer of claim 9, wherein the software incorporates proper diagnostic procedures and assesses penalties and costs associated with user procedures in comparison with proper diagnostic procedures.

13. The field technician trainer of claim 1, wherein the software is organized and configured into an interactive game-styled presentation.

14. The field technician trainer of claim 1, wherein the software is organized and configured into a menu-driven presentation with selectable options and actions and corresponding results.

15. The field technician trainer of claim 1, wherein the interactive software includes an administrative functions module that enables an administrator to load selectable characteristics and network problems into the virtual broadband communication network environment.

16. The field technician trainer of claim 1, wherein the software enables selections by a user including inspection, replacement, measurement and adjustment.

17. The field technician trainer of claim 1, wherein the software includes a plurality of digital representations of actual network components to provide visual training.

18. The field technician trainer of claim 1, wherein the software includes a plurality of digitized clips that are presented at appropriate times during a training session to enhance training.

19. The field technician trainer of claim 18, wherein the digitized clips include at least one television screen clip, and wherein each television screen clip reflects actual television response indicative of a corresponding network problem.

20. The field technician trainer of claim 18, wherein the digitized clips include audio clips that guide a user and that aid in diagnostic procedure.

21. The field technician trainer of claim 1, wherein the interactive software modules include a truck stock module that determines truck stock and consumption thereof.

22. A method of training a field technician, comprising:
providing an interactive virtual broadband communication network environment on a computer;
presenting at least one description indicative of a network problem; and
presenting selectable options and actions and corresponding results to simulate realworld trouble-shooting that enables a user to interact with the virtual broadband communication network environment while attempting to identify the network problem.

23. The method of claim 22, wherein said presenting at least one description comprises displaying a trouble ticket including a subscriber complaint.

24. The method of claim 22, wherein said presenting selectable options and actions includes displaying a selectable map icon and displaying a cable plant with selectable network component graphics upon user selection of the map icon.

25. The method of claim 24, further comprising displaying component information of a network component of the cable plant upon selection of a corresponding network component graphic.

26. The method of claim 22, wherein said providing a virtual broadband communication network environment includes displaying a virtual representation of a cable plant including a neighborhood with selectable subscriber locations and network components for inspection.

27. The method of claim 26, further comprising incorporating virtual measurable values associated with selectable network components indicative of network status and operation and reflecting a selected network problem.

28. The method of claim 27, further comprising displaying selectable icons of virtual test equipment that enables a user to select a virtual test device and determine measurable values of network components to simulate trouble-shooting procedure.

29. The method of claim 28, wherein said presenting selectable options and actions includes incorporating a series of options and actions corresponding with predetermined proper procedure for a selected network problem.

30. The method of claim 29, further comprising evaluating user procedure compared to the predetermined proper procedure.

31. The method of claim 30, further comprising reporting outcome, progress and performance of the user.

32. The method of claim 30, further comprising providing a user score based on difficulty level, skill level, and costs.

33. The method of claim 22, further comprising presenting digitized clips at appropriate times during a training session to enhance user training experience.
